(19) United States
(12) Patent Application Publication
(10) Pub. No.: US 2025/0215950 A1
(43) Pub. Date: Jul. 3, 2025

(54) FRICTION ASSEMBLY HAVING A FRICTION FRAME AND WEAR LINER

(71) Applicant: Transportation IP Holdings, LLC, Norwalk, CT (US)

(72) Inventors: A. Gary Bowden, Laurinburg, NC (US); James Wesley Sugg, Pinehurst, NC (US)

(73) Assignee: Transportation IP Holdings, LLC, Norwalk, CT (US)

(21) Appl. No.: 19/008,394

(22) Filed: Jan. 2, 2025

Related U.S. Application Data
(60) Provisional application No. 63/617,199, filed on Jan. 3, 2024.
(60) Provisional application No. 63/664,563, filed on Jun. 26, 2024.

(51) Int. Cl. F16F 7/08

(52) U.S. Cl. CPC F16F 7/08; F16F 2222/04; F16F 2232/08; F16F 2236/103

(57) ABSTRACT

A friction assembly is provided that can include a body, a frame, and a wear liner. The body can include a first connection side having a cavity with one or more protrusions. The frame can be coupled with the one or more protrusions. The frame can have a first wear surface that can engage a working surface of a vehicle. The wear liner can be coupled to the first connection side of the body and the frame. The wear liner can have a second wear surface to engage the working surface. The wear liner can be coupled with the frame such that at least a portion of the wear liner is positioned between the frame and the body. The frame and the wear liner can be comprised of different materials. For example, the frame can be comprised of metal and the wear liner can be comprised of a composite material.

### CROSS-REFERENCE TO RELATED APPLICATIONS

This application claims priority under 35 U.S.C. § 119 (e) to U.S. Provisional Patent Application No. 63/617, 199, titled FRICTION ASSEMBLY HAVING A FRICTION FRAME AND WEAR LINER, filed Jan. 3, 2024, and to U.S. Provisional Patent Application No. 63/664,563, titled FRICTION ASSEMBLY HAVING A FRICTION FRAME WITH BONDING FEATURES, filed Jun. 26, 2024, the disclosure of each of which is herein incorporated by reference in its entirety.

### BACKGROUND

### Technical Field

The subject matter described herein relates to friction assemblies of vehicles.

### Discussion of Art

In various applications, vehicles and vehicle systems can include components that may need frictional support, for example, to serve as shock absorbers, braking devices, suspension devices, or the like. In various systems, including rail vehicle systems, each vehicle may have many of these types of components. In some aspects, these components may be high-friction components, which can include friction wedges, constant contact side bearings, center bowl wear liners, coupler carrier wear plate, brake beam extension heads, and the like. Such components can be positioned in a vehicle to engage under pressure with another vehicle component while one or both components move relative to eat other. It should be appreciated, however, that the problems with such components discussed herein and the solutions to such problems described herein are not limited to such example components.

In general, when one or more engaging components move relative to one another, friction may be created, or exist, between the components. The friction that is created, or exists, between the components serves a function in the control of the vehicle during movement of the vehicle system. One such function, for example, is to provide damping characteristics to control ride quality of the vehicle system.

The friction components may be assembled as friction, or wear, assemblies. Currently, friction assemblies may include a wear liner that may be all metal. All metal wear liners may provide for a metal-to-metal contact between the friction assemblies and the engagement surface. This metal-to-metal contact may produce very high amounts of friction between these components and may cause high rates of wear on the engaging surfaces. This metal-to-metal contact often creates a slip stick effect that may be hard to control, and which may vary with environmental changes (such as dramatic temperature swings or humidity changes). Further, metal wear liners may not be able to be molded on to other parts, for example constant contact side bearings, friction wedges, or the like. Further, the metal wear liners may prematurely wear the corresponding component with which the wear liner engages. The metal wear liners may have a high static friction, which may cause slip stick when direction is changed in reciprocating applications rubbing against another metal, such as a wear plate. This may cause a rough, jerky movement and high forces in the adjacent components or systems.

Friction assemblies may include all composite wear liners bonded to the friction assembly. All composite wear liners may have a limit on compressive strength and, therefore, may not be able to be used on heavily-loaded applications. The bonded wear liner may be prone to chipping and delaminating from the friction assembly engagement face. All composite wear liners may have a limit on maximum temperature, which may be generated by high loads during high rubbing speeds. Smearing or melting can occur under high loads or high rubbing speeds. Further, the composite wear liners are generally employed as sacrificial elements which are manufactured to be worn out and replaced after certain periods of time or service. The need to regularly replace these worn, damaged, or destroyed wear liners increases the overall maintenance needed for vehicles employing such friction assemblies with these wear liners, and thus increases the overall cost of operating the vehicle with such friction assemblies.

Currently, friction assemblies may include a wear liner that may be coupled to a body or frame. The bonding of the wear liner to the body or frame may not include mechanical bond features and/or chemical bonding features, which may result in the wear liner chipping, breaking, or otherwise having material loss.

The material loss may be due to the wear liner being relatively thin due to space constraints of the friction assembly. Further, the wear liner may lack elasticity or flexibility because the wear liner may be designed to achieve long wear life and may be suitable for high loading and impact forces. The edges and/or corners of the wear liner may be subject to high loading and impact forces because the face of the friction assembly may not remain aligned and mated with the wear liner and wear surface. The high loads and impacts are typical of freight rail service due to the condition of the rail, freight cars, or the like.

The wear liner may have thermal expansion and contraction properties different from the body or frame it is attached to, as the body or frame may be more conductive of heat. Further, the cooling rate of the wear liner and the body or frame may be different. These factors may cause separation between the wear liner and the body or frame.

Accordingly, it may be desirable to provide a friction assembly that differs from existing friction assemblies.

### BRIEF DESCRIPTION

In accordance with one example or aspect, a friction assembly is provided that includes a metal frame and a wear liner. The metal frame may define an array with interstices. The metal frame may have a first wear surface disposed around the interstices and may engage a working surface of a vehicle. The wear liner may be coupled to the metal frame within the interstices of the metal frame and define a second wear surface to engage the working surface of the vehicle. The wear liner may cover the first wear surface of the metal frame such that the second wear surface of the wear liner may initially engage the working surface of the vehicle exclusive of the first wear surface. The wear liner may wear down over time through frictional engagement with the working surface until the second wear surface is coplanar with the first wear surface to engage the working surface of the vehicle together. The first wear surface and the second wear surface are coplanar and positioned to engage the working surface of the vehicle together.

In accordance with one example or aspect, a friction component is provided that includes a metal frame and a wear liner. The metal frame may define a mesh array with interstices. The metal frame may have a first friction surface disposed around the interstices and may engage a working surface of a vehicle. The wear liner may be coupled to the metal frame at the interstices of the metal frame and may define a second friction surface to engage the working surface. The wear liner may extend past and cover the first friction surface of the metal frame for the second friction surface of the wear liner to initially engage the working surface of the vehicle exclusive of the first friction surface. The wear liner may wear down over time through frictional engagement with the working surface of the vehicle until the second friction surface is coplanar with the first friction surface to engage the working surface of the vehicle together. The first friction surface and the second friction surface may be coplanar and positioned to engage the working surface of the vehicle together.

In accordance with one example or aspect, a friction assembly is provided that includes a body and a wear liner. The body may include a support frame with interstices. The support frame may have a first friction surface disposed around the interstices and may engage a working surface of a vehicle. The wear liner may be coupled to the support frame within the interstices of the support frame and may define a second friction surface that may engage the working surface of the vehicle. The wear liner may be coupled with the support frame such that at least a portion of the wear liner is positioned between the support frame and the body. The wear liner may extend past and cover the first friction surface of the support frame for the second friction surface of the wear liner to initially engage the working surface of the vehicle exclusive of the first friction surface. The wear liner may wear down over time through frictional engagement with the working surface of the vehicle until the second friction surface lies within the interstices and is coplanar with the first friction surface to engage the working surface of the vehicle together. The wear liner may define the second friction surface in the interstices of the support frame, and the first friction surface and the second friction surface may be coplanar and positioned to engage the working surface of the vehicle together.

In accordance with at least one example or aspect, a friction assembly is provided that can include a body, a frame, and a wear liner. The body can include a first connection side that can have a cavity with one or more protrusions. The frame can be coupled with or mounted to the one or more protrusions. The frame can include a first wear surface to engage a working surface of a vehicle. The wear liner can be coupled to the first connection side of the body and the frame. The wear liner can have a second wear surface to engage the working surface of the vehicle. The wear liner can be coupled with the frame such that at least a portion of the wear liner is positioned between the frame and the body.

In accordance with at least one example or aspect, a friction component is provided that can include a body, a frame, and a wear liner. The body can include a first connection side having a cavity with one or more protrusions. The frame can be coupled with or mounted to the one or more protrusions. The frame can define a mesh array with interstices having a first friction surface disposed around the interstices to engage a working surface of the vehicle. The wear liner can be coupled to frame at the interstices. The wear liner can define a second friction surface to engage the working surface. The wear liner can be coupled with the frame such that at least a portion of the wear liner is positioned between the frame and the body.

In accordance with at least one example or aspect, a friction assembly is provided that can include a body and a wear liner. The body can include a cavity having one or more protrusions and a support frame with interstices. The support frame can have a first friction surface disposed around the interstices to engage a working surface of a vehicle. The wear liner can be coupled to the support frame and defining a second friction surface to engage the working surface. The wear liner can be coupled with the support frame such that at least a portion of the wear liner can be positioned between the support frame and the body.

### BRIEF DESCRIPTION OF THE DRAWINGS

The subject matter may be understood from reading the following description of non-limiting examples, with reference to the attached drawings, wherein below:

FIG. 1 is a perspective view of a friction assembly positioned relative to a working surface of a vehicle, according to at least one example of the present disclosure.

FIG. 2 is a side view of the friction assembly of FIG. 1 positioned relative to working surfaces of a vehicle, according to at least one example of the present disclosure.

FIG. 3A is a perspective view of a wear liner of the friction assembly of FIG. 1, according to at least one example of the present disclosure.

FIG. 3B is a perspective view of a frame of the friction assembly of FIG. 1, according to at least one example of the present disclosure.

FIG. 3C is a perspective view of the wear liner of FIG. 3A coupled to the frame of FIG. 3B to form a wear surface, according to at least one example of the present disclosure.

FIG. 4A is a front view of the wear surface of FIG. 3C, according to at least one example of the present disclosure.

FIG. 4B is a cross-sectional view along A-A of the wear surface of FIG. 4A, according to at least one example of the present disclosure.

FIG. 4C is a cross-sectional view along B-B of the wear surface of FIG. 4A, according to at least one example of the present disclosure.

FIG. 5A is a front view of the friction assembly of FIG. 1, according to at least one example of the present disclosure.

FIG. 5B is a cross-sectional view along C-C of the friction assembly of FIG. 5A, according to at least one example of the present disclosure.

FIG. 6 is a perspective view of the friction assembly of FIG. 1, of another state, according to at least one example of the present disclosure.

FIG. 7 is a perspective view of the wear surface of the friction assembly of FIG. 1 in another state of FIG. 6, according to at least one example of the present disclosure.

FIG. 8 is a perspective view of a friction assembly, according to at least one example of the present disclosure.

FIG. 9A is a perspective view of a wear liner of the friction assembly of FIG. 8, according to at least one example of the present disclosure.

FIG. 9B is a perspective view of a frame of the friction assembly of FIG. 8, according to at least one example of the present disclosure.

FIG. 9C is a perspective view of the wear liner of FIG. 9A coupled to the frame of FIG. 9B to form a wear surface, according to at least one example of the present disclosure.

FIG. 10 is a perspective view of the wear surface of FIG. 9C in another state, according to at least one example of the present disclosure.

FIG. 11 is a perspective view of a friction assembly, according to at least one example of the present disclosure.

FIG. 12 is another perspective view of the friction assembly of FIG. 11, according to at least one example of the present disclosure.

FIG. 13A is a perspective view of a wear liner of the friction assembly of FIG. 11, according to at least one example of the present disclosure.

FIG. 13B is a perspective view of a frame of the friction assembly of FIG. 11, according to at least one example of the present disclosure.

FIG. 13C is a perspective view of the wear liner of FIG. 13A coupled to the frame of FIG. 13B to form a wear surface, according to at least one example of the present disclosure.

FIG. 14 is a perspective view of the wear surface of FIG. 13C in another state, according to at least one example of the present disclosure.

FIG. 15 is a perspective view of the friction assembly of FIG. 11 in another state, according to at least one example of the present disclosure.

FIG. 16 is a perspective view of the friction assembly of FIG. 11 in another state, according to at least one example of the present disclosure.

FIG. 17 is a perspective view of a constant contact side bearing assembly and a working surface of a vehicle, according to at least one example of the present disclosure.

FIG. 18A is an exploded, side view of the constant contact side bearing assembly of FIG. 17, according to at least one example of the present disclosure.

FIG. 18B is an exploded, cross-sectional view along D-D of the constant contact side bearing assembly of FIG. 18A, according to at least one example of the present disclosure.

FIG. 19A is a side view of the constant contact side bearing assembly of FIG. 17, according to at least one example of the present disclosure.

FIG. 19B is a cross-sectional view along E-E of the constant contact side bearing assembly of FIG. 19A, according to at least one example of the present disclosure.

FIG. 20A is a top view of a frame of the constant contact side bearing assembly of FIG. 17, according to at least one example of the present disclosure.

FIG. 20B is a perspective view of a wear liner of the constant contact side bearing assembly of FIG. 17, according to at least one example of the present disclosure.

FIG. 20C is a perspective view of the frame of FIG. 20A coupled to the wear liner of FIG. 20b to form a wear surface, according to at least one example of the present disclosure.

FIG. 21 is a perspective view of the wear surface of FIG. 20C in another state, according to at least one example of the present disclosure.

FIG. 22 is a perspective view of the constant contact side bearing assembly of FIG. 17 in another state, according to at least one example of the present disclosure.

FIG. 23A is a perspective view of a frame of a constant contact side bearing, according to at least one example of the present disclosure.

FIG. 23B is a top view of the frame of FIG. 23A, according to at least one example of the present disclosure.

FIG. 24A is a perspective view of the frame of FIG. 23A coupled to a wear liner to form a wear surface, according to at least one example of the present disclosure.

FIG. 24B is a perspective view of the wear surface of FIG. 24A in another state, according to at least one example of the present disclosure.

FIG. 25A is a perspective view of a frame of a constant contact side bearing, according to at least one example of the present disclosure.

FIG. 25B is a top view of the frame of FIG. 25A, according to at least one example of the present disclosure.

FIG. 26A is a perspective view of the frame of FIG. 25A coupled to a wear liner to form a wear surface, according to at least one example of the present disclosure.

FIG. 26B is a perspective view of the wear surface of FIG. 25A in another state, according to at least one example of the present disclosure.

FIG. 27A is a top view of a frame of a center bowl liner, according to at least one example of the present disclosure.

FIG. 27B is a cross-sectional view along F-F of the frame of the center bowl liner of FIG. 27A, according to at least one example of the present disclosure.

FIG. 27C is a cross-sectional view along G-G of the frame of the center bowl liner of FIG. 27A, according to at least one example of the present disclosure.

FIG. 28A is a top view of the frame of FIG. 27A coupled to a wear liner to form a wear surface, according to at least one example of the present disclosure.

FIG. 28B is a cross-sectional view along H-H of the wear surface of the center bowl liner of FIG. 28A, according to at least one example of the present disclosure.

FIG. 28C is a cross-sectional view along I-I of the wear surface of the center bowl liner of FIG. 28A, according to at least one example of the present disclosure.

FIG. 29A is a top view of the wear surface of FIG. 28A, of a first state, according to at least one example of the present disclosure.

FIG. 29B is a cross-sectional view along J-J of the wear surface of the center bowl liner of FIG. 29A, according to at least one example of the present disclosure.

FIG. 29C is a cross-sectional view along K-K of the wear surface of the center bowl liner of FIG. 29A, according to at least one example of the present disclosure.

FIG. 30A is a top view of a frame of a carrier coupler base, according to at least one example of the present disclosure.

FIG. 30B is a cross-sectional view along L-L of the frame of the carrier coupler base of FIG. 30A, according to at least one example of the present disclosure.

FIG. 31A is a perspective view of the frame of FIG. 30A coupled to a wear liner to form a wear surface, according to at least one example of the present disclosure.

FIG. 31B is a perspective view of the wear surface of FIG. 31A in another state, according to at least one example of the present disclosure.

FIGS. 32A1 and 32A2 are a top view and a cross-sectional view, respectively, of a frame of a carrier coupler base, according to at least one example of the present disclosure.

FIGS. 32B1 and 32B2 are a top view and a cross-sectional view, respectively, of a frame of a carrier coupler base, according to at least one example of the present disclosure.

FIGS. 32C1 and 32C2 are a top view and a cross-sectional view, respectively, of a frame of a carrier coupler base, according to at least one example of the present disclosure.

FIGS. 32D1 and 32D2 are a top view and a cross-sectional view, respectively, of a frame of a carrier coupler base, according to at least one example of the present disclosure.

FIGS. 32E1 and 32E2 are a top view and a cross-sectional view, respectively, of a frame of a carrier coupler base, according to at least one example of the present disclosure.

FIG. 32F1 and 32F2 are a top view and a cross-sectional view, respectively, of a frame of a carrier coupler base, according to at least one example of the present disclosure.

FIG. 33A is a top view of a frame of a carrier coupler base, according to at least one example of the present disclosure.

FIG. 33A is a cross-sectional view along S-S of the frame of the carrier coupler base of FIG. 33A, according to at least one example of the present disclosure.

FIG. 34A is a perspective view of the frame of FIG. 33A coupled to a wear liner to form a wear surface, according to at least one example of the present disclosure.

FIG. 34B is a perspective view of the wear surface of FIG. 34A in another state, according to at least one example of the present disclosure.

FIG. 35 is a perspective view of a friction assembly positioned relative to a working surface of a vehicle, according to at least one example of the present disclosure.

FIG. 36 is an exploded view of the friction assembly of FIG. 35, according to at least one example of the present disclosure.

FIG. 37 is a perspective view of the friction assembly of FIG. 35 with the wear liner removed for illustrative purposes, according to at least one example of the present disclosure.

FIG. 38A is a front view of the friction assembly of FIG. 35, according to at least one example of the present disclosure.

FIG. 38B is a front view of the friction assembly of FIG. 35 with the wear liner removed for illustrative purposes, according to at least one example of the present disclosure.

FIG. 39A is a cross-sectional view along A1-A1 of the friction assembly of FIG. 38A, according to at least one example of the present disclosure.

FIG. 39B is a cross-sectional view along B1-B1 of the friction assembly of FIG. 38B, according to at least one example of the present disclosure.

FIG. 40 is a perspective view of the friction assembly of FIG. 35 in another state, according to at least one example of the present disclosure.

FIG. 41 is a cross-sectional view along C1-C1 of the friction assembly of FIG. 40, according to at least one example of the present disclosure.

FIG. 42 is a perspective view of a friction assembly, according to at least one example of the present disclosure.

FIG. 43 an exploded view of the friction assembly of FIG. 42, according to at least one example of the present disclosure.

FIG. 44 is a perspective view of the friction assembly of FIG. 42 with the wear liner removed for illustrative purposes, according to at least one example of the present disclosure.

FIG. 45A is a front view of the friction assembly of FIG. 44 with certain hidden features depicted with dashed lines for illustrative purposes, according to at least one example of the present disclosure.

FIG. 45B is a cross-sectional view along E1-E1 of a wear surface of the friction assembly of FIG. 45A, according to at least one example of the present disclosure.

FIG. 46 is a cross-sectional view along D1-D1 of the friction assembly of FIG. 42, according to at least one example of the present disclosure.

FIG. 47 is a perspective view of the friction assembly of FIG. 42 in another state, according to at least one example of the present disclosure.

FIG. 48 is a cross-sectional view along F1-F1 of the friction assembly of FIG. 47, according to at least one example of the present disclosure.

FIG. 49 is a perspective view of a friction assembly, according to at least one example of the present disclosure.

FIG. 50 an exploded view of the friction assembly of FIG. 49, according to at least one example of the present disclosure.

FIG. 51 is a perspective view of the friction assembly of FIG. 49 with the wear liner removed for illustrative purposes, according to at least one example of the present disclosure.

FIG. 52A is a front view of the friction assembly of FIG. 49, according to at least one example of the present disclosure.

FIG. 52B is a cross-sectional view along G1-G1 of the friction assembly of FIG. 49, according to at least one example of the present disclosure.

FIG. 53A is a front view of the friction assembly of FIG. 49 in another state, according to at least one example of the present disclosure.

FIG. 53B is a cross-sectional view along H1-H1 of the friction assembly of FIG. 53A, according to at least one example of the present disclosure.

FIG. 54 is a top view of a friction assembly, according to at least one example of the present disclosure.

FIG. 55 is a cross-sectional view along I1-I1 of the friction assembly of FIG. 54, according to at least one example of the present disclosure;

FIG. 56 is a top view of the friction assembly of FIG. 54, and further including a frame, according to at least one example of the present disclosure;

FIG. 57 is a cross-sectional view along J1-J1 of the friction assembly of FIG. 22, including the frame positioned above a cavity of the friction assembly, according to at least one example of the present disclosure;

FIG. 58 is a cross-sectional view along J1-J1 of the friction assembly of FIG. 22, including the frame positioned inside a cavity of the friction assembly, according to at least one example of the present disclosure;

FIG. 59 is a cross-sectional view along J1-J1 of the friction assembly of FIG. 22, and further including a wear liner in a first state, according to at least one example of the present disclosure; and

FIG. 60 is a cross-sectional view along J1-J1 of the friction assembly of FIG. 22, and further including a wear liner in a second state, according to at least one example of the present disclosure.

### DETAILED DESCRIPTION

Examples of the subject matter described herein relate to friction assemblies that serve as a shock absorber in the suspension of vehicles or components thereof, and more particularly, the subject matter herein relates to a system and method for improved durability and bonding of a wear liner of a friction assembly. The friction assembly may include friction wedges, constant contact side bearings, center bowl liners, coupler carrier wear plates, roller bearing adapters, roller bearing adapter liners, side bearing walls, brake beam extension heads, or the like. The friction assembly may include an outer wear liner that may be coupled to the friction assembly. The wear liner may be positioned to include a wear surface to engage a working surface of the vehicle. The wear liner may be a composite material that may assist in more precisely and uniformly controlling the amount of friction between the wear surface and the working surface of the vehicle. The wear liner may be mounted or coupled to a frame and a body that provide support to the wear liner. The frame may include a wear surface to engage the working surface of the vehicle. The frame may allow a much higher range of pressure and temperature applications to the friction assembly. The body may include a cavity having one or more protrusions. The wear liner may be mounted or coupled to the cavity and/or protrusions of the body such that at least a portion of the wear liner is positioned between the frame and the body.

The ratio of the frame to the wear liner may be adjusted to provide a customized friction performance and/or wear rate. The body and cavity may be designed and shaped such that the wear liner material can flow around the cavity and the protrusions to interlock inside and underneath sections of the frame to prevent loss of the wear liner material.

The combination of the frame and the wear liner may both work at the working surface to provide the desired friction support. In this way, the frame is not solely a support member, but rather is also part of the wear surface. The material and quantity of the wear liner may be customizable based on desired friction performance/characteristics and wear rate. The material and shape of the frame may also be customizable to further customize the friction performance. The frame may be a metal, alloy, casting, sintered, 3D printed materials or metals, or the like. The combination of the wear liner and the frame can provide a customizable friction performance range, including a low friction, mid-friction, high friction, and very low friction/lubricants. The frame and wear liner may act to provide desired friction level, without deformation, melting, smearing, crushing, while limiting wear on the wear surfaces, extending the life of the wear surfaces.

Additionally, the frame may act as a heat sink to allow heat to be transferred away from the wear surface of the wear liner through the frame to the supporting, non-wear surfaces of the frame.

The vehicles and vehicle systems described herein extend to multiple types of vehicles or vehicle systems. Suitable vehicle types may include automobiles, trucks with or without trailers, rail vehicles or rail vehicle systems, buses, marine vessels, manned or unmanned aircraft, mining vehicles, agricultural vehicles, other off-highway vehicles, or the like. The vehicle systems described herein, including rail vehicle systems or other vehicle systems that do not travel on rails or tracks, can be formed from a single vehicle or multiple vehicles. With respect to multi-vehicle systems, the vehicles can be mechanically coupled with each other (e.g., by couplers) or logically coupled, but not mechanically coupled. For example, vehicles may be logically, but not mechanically, coupled when the separate vehicles communicate with each other to coordinate movements of the vehicles with each other so that the vehicles travel together as a group. Vehicle systems may also be referred to as vehicle groups, convoys, consists, swarms, fleets, platoons, trains, etc.

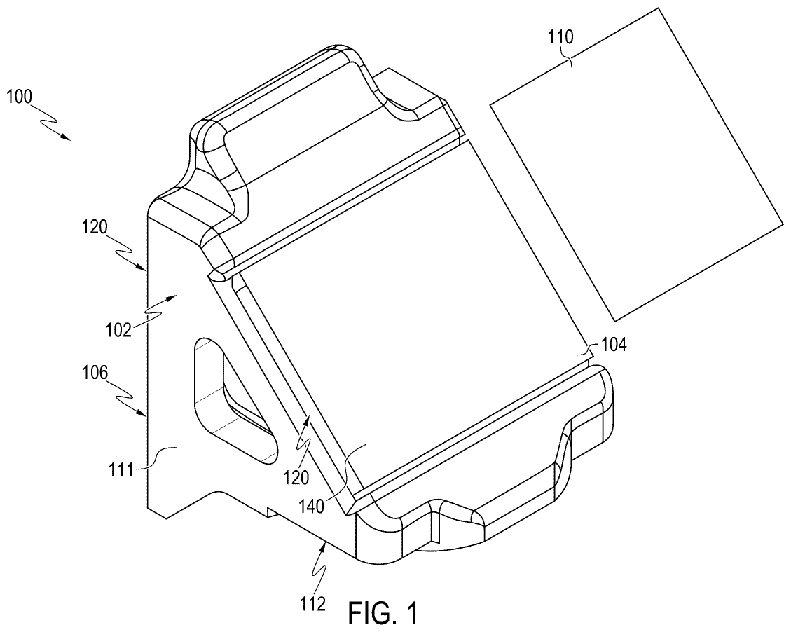

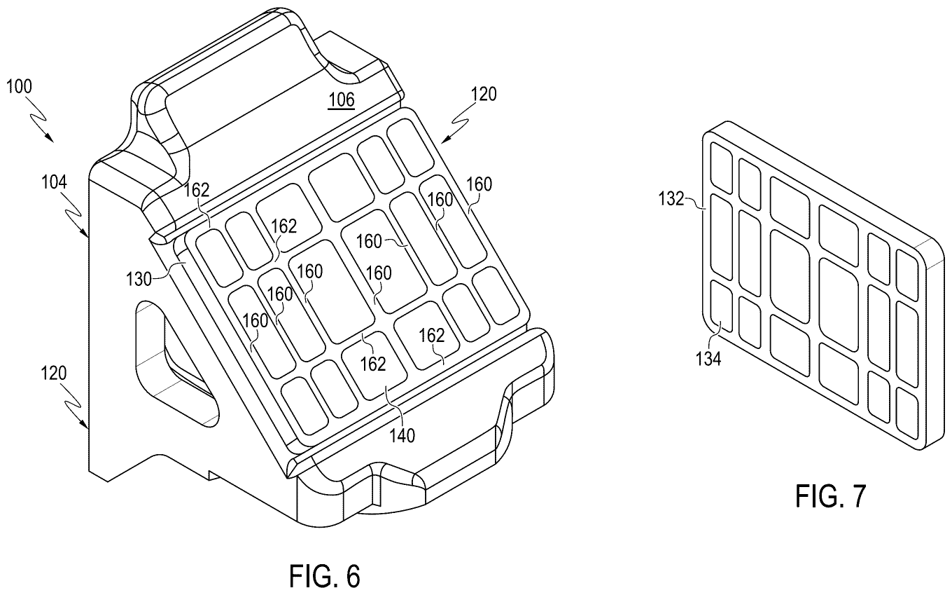

FIG. 1 illustrates an example of a friction assembly 100, according to at least one example of the present disclosure. The friction assembly 100 is a friction wedge assembly in various aspects of the present disclosure. The friction assembly 100 in FIG. 1 may be in an initial state, which corresponds to a non-worn state in many aspects of the present disclosure. The friction assembly 100 is further depicted in another state in FIG. 6, which corresponds to a worn state in many aspects of the present disclosure.

The friction assembly 100 may include a body 102, a sloped surface 104, a front surface 106, side walls 111, a base surface 112, and one or more wear surfaces 120. The wear surfaces 120 may be positioned to engage corresponding working surfaces 110 of a vehicle. The working surfaces 110 of the vehicle may be wear plates, side frames, or the like. A frictional force generated by the wear surfaces engagement with the working surfaces may dampen movement of a vehicle component relative to the friction assembly and may result in a smoother, less bumpy ride for the vehicle and components thereof.

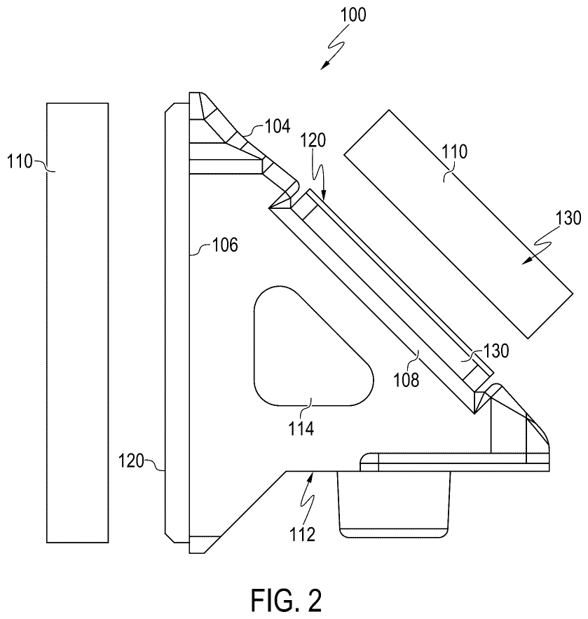

The friction assembly 100 may be used in a suspension system of a vehicle. In one example, the sloped surface and the front surface may be positioned to be wear surfaces that engage working surfaces of the vehicle. The sloped surface may include a frame attachment surface 108 (FIG. 2) that may be positioned to receive and/or be coupled with a frame 130. The frame attachment surface 108 may be a pocket in the sloped surface 104 that may receive the frame. In another example, the frame attachment surface 108 may be flush with the sloped surface 104. The frame 130 may frictionally engage a corresponding sloped wall of the vehicle, for example.

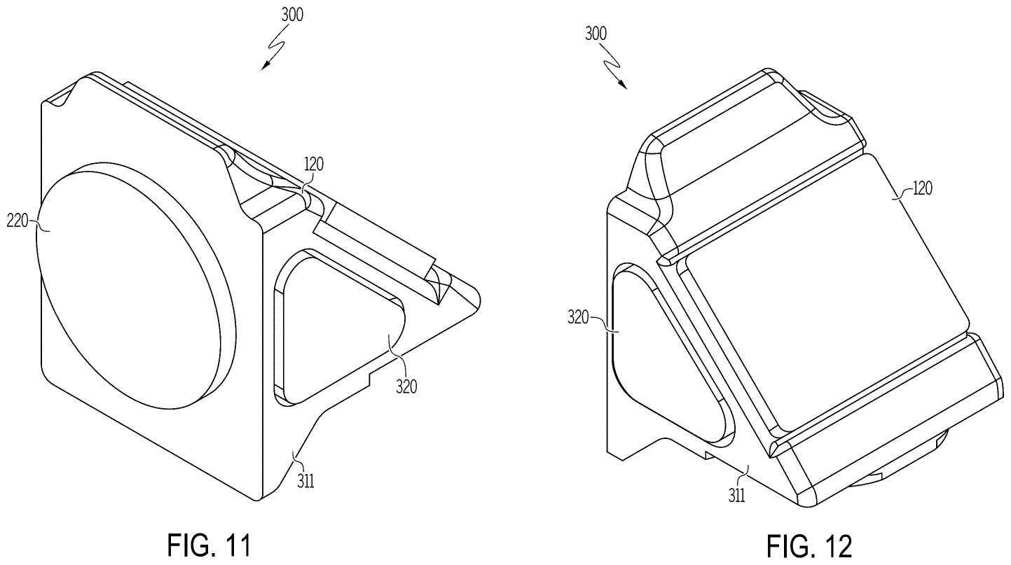

As illustrated in FIG. 2, the rear surface, which corresponds to the sloped surface 104 in the friction assembly 100, may be a wear surface. The rear surface may engage an inner surface of a side frame column of a vehicle. The friction assembly 100 may initially be positioned with wear surfaces in working positions to engage working surfaces 110 of the vehicle. The friction assembly 100 may move up and down and/or side to side relative to the working surfaces 110 of the vehicle. Additionally, the body 102 of the friction assembly 100 may include one or more lateral apertures 114 on a side wall 111 of the body 102 that may be open to an interior of the body. In other embodiments, referring to FIGS. 11 and 12, for example, side walls of the friction assembly's body may include additional wear surfaces instead of lateral apertures.

The frame 130 and the wear liner 140 can be comprised of different materials. For example, the frame 130 can be comprised of a metal material, and the wear liner 140 can be comprised of a non-metal material, as further disclosed herein. The different materials of the frame 130 and the wear liner 140 can define different coefficients of friction. Moreover, the different materials can wear down differently. For example, the wear liner 140 can be formed from a material that wears down faster than the frame 130, as further disclosed herein.

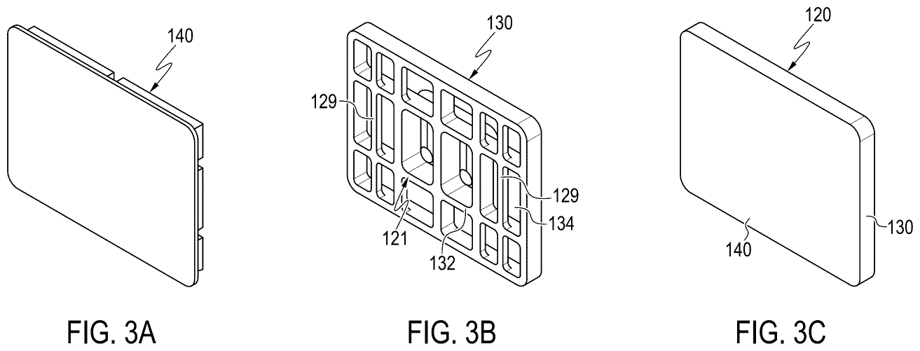

The frame 130 may be coupled with the frame attachment surface 108. In other examples, a frame may be attached to one or more different portions of the friction assembly 100, specifically, at one or more wear surfaces of the friction assembly 100. The frame 130 may be formed from cast iron, forged iron, cast steel, forged steel, sintered metal, alloys, aluminum, 3D printed materials or metals, a combination of metals, or the like. The frame 130 may be welded to the frame attachment surface 108, integrally incorporated into the wedge assembly 100, removably coupled to the frame attachment surface 108 via mechanical fasteners, or the like. Referring primarily to FIG. 3B, the frame 130 may define an array 132 with interstices 134. A first wear surface 121 may be disposed around the interstices and may engage the working surface of the vehicle. The material of the frame 130 may be selected based on a desired friction performance with the working surface of the vehicle. The material of the frame 130 may also be selected to be rigid to provide support and extended wear life.

A wear liner 140 may be coupled or bonded to the first connection side, or engagement surface, and/or the frame. The wear liner 140 may be made from a suitable material having a low coefficient of friction to engage the working surface of the vehicle, dry self-lubricating and non-hydroscopic characteristics, a high compressive strength, and a high resistance to wear. In one example, the wear liner 140 may be formed from a high-density polyethylene, which is often referred to as an ultra-high molecular weight polyethylene. In another example, the wear liner 140 may be formed from a high-density polypropylene. In other examples, the wear liner 140 may be formed from a nylon, a graphite, or a urethane such as an oil-filled urethane. However, the wear liner 140 may be formed from certain combinations of materials, composite materials, or may be an impregnated material. The material of the wear liner 140 may be selected based on a desired friction performance with the working surface of the vehicle, a desired wear life, or the like.

The wear liner 140 may be coupled to the cavity of the body 102. This may allow the wear liner to fully encapsulate and surround the frame 130 for a greater mechanical bond to the frame 130. The cavity may further allow for a thicker wear liner that may be contained on all sides by the cavity, such that the cavity may function as a pocket to contain the wear liner 140. The wear liner 140 may extend beyond the cavity towards the working surface of the vehicle to act as a first wear surface.

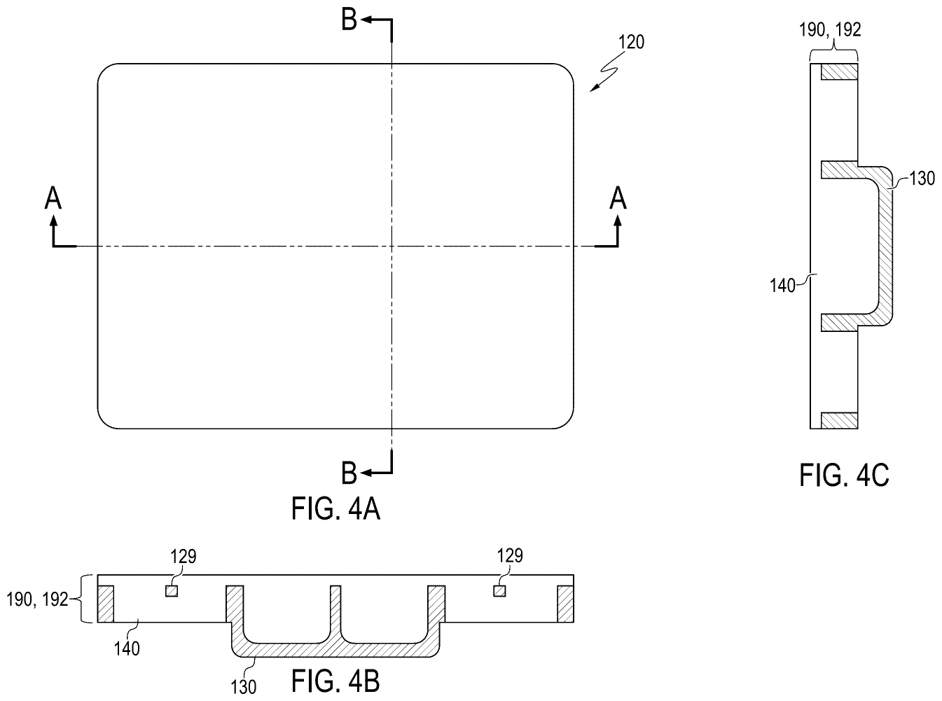

The wear liner 140 may be coupled with the frame 130, such that the frame may provide a structural support to the wear liner 140. The wear liner 140 may be malleable during the coupling to the body 102 and the frame 130, such that the wear liner 140 may surround all or a portion of the frame 130 to form a strong connection, as described further below with respect to FIG. 4B, for example. The wear liner 140 may be received and coupled to the cavity and protrusions of the body 102, such that at least a portion of the wear liner 140 may be positioned between the frame 130 and the body 102.

FIG. 3A depicts the wear liner 140 in a removed position, not coupled to the frame 130. The wear liner 140 may be shown with indentions corresponding to where the frame 130 may be coupled with the wear liner 140. FIG. 3B depicts the frame 130 in a removed position, not coupled to the wear liner 140. The frame 130 may have the array 132 and interstices 134. The frame 130 may be coupled to the frame attachment surface. However, at least a portion 129 of the frame 130 may be spaced apart from the frame attachment surface 108. The portion of the frame 130 spaced apart from the frame attachment surface 108 may provide a gap between the portion of the frame 130 and the frame attachment surface 108. The wear liner 140 may be coupled to the portion of the frame 130 such that the wear liner 140 may surround the frame 130 and be coupled with the wear liner 140 positioned between the portion of the frame 130 and the frame attachment surface 108.

While the portion of the frame 130 spaced apart from the frame attachment surface 108 may be shown as two vertical portions of the array in FIG. 3B, in other examples, other or additional portions of the frame may be spaced apart from the frame attachment surface. In one example, a perimeter of the frame 130 may engage the frame attachment surface 108 and interior portions of frame 130 may be spaced apart from the frame attachment surface 108. In another example, the perimeter of the frame 130 may be spaced from the frame attachment surface 108 and interior portions of the frame 130 may engage the frame attachment surface 108.

FIG. 3C illustrates the wear liner 140 of FIG. 3A coupled to the frame 130 of FIG. 3b to form the wear surface 120. The frame 130 may provide a higher degree of structural support compared to the wear liner 140 coupled to the friction assembly 100 without the frame 130. The structural support provided by the frame 130 may reduce crushing, smearing, deformation, or the like of the wear liner 140. Additionally, the frame 130 may provide additional frictional engagement with the wear liner 140 to the working surfaces 110 of the vehicle. The wear liner 140 may be coupled to the frame 130 via chemical bonding (e.g., by adhesive), mechanical fasteners, molding to the frame, or the like.

Referring primarily now to FIG. 4B, at least the portion 129 of the frame 130 may be spaced from the frame attachment surface 108, such that at least a portion of the wear liner 140 may be coupled to the frame 130 between the frame 130 and the frame attachment surface 108. The frame 130 may have multiple portions that may be spaced apart from the frame attachment surface 108. Additionally, the wear liner 140 may be coupled to the frame 130 between the frame 130 and the wear surface 120, such that at least a portion of the frame 130 is surrounded by the wear liner 140. Said another way, the wear liner 140 may be attached to all sides of the portion of the frame 130 to increase the bond strength. The arrangement of the frame 130 may increase the strength of the bond, as there may be both a mechanical bond and a chemical bond. The array 132 with interstices 134 may provide a means of mechanical interlock between the molded wear liner 140 and the frame 130. Additionally, the arrangement may reduce the detachment of the wear liner 140 from the frame 130 and reduce the chipping, shearing, and/or removal of the wear liner 140, which may increase the wear life of the wear liner 140.

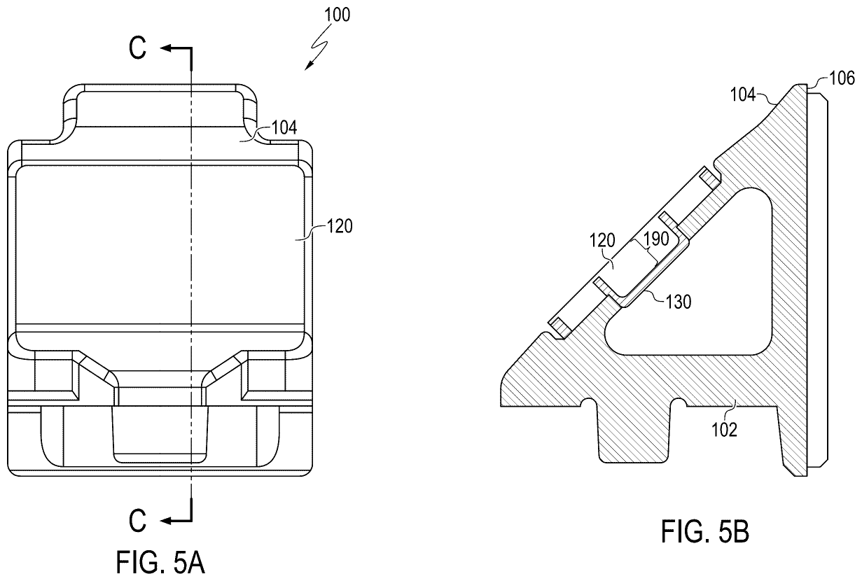

In the example illustrated in FIGS. 1-5, the wear liner 140 may initially be coupled with the frame 130 such that the wear liner 140 makes up all or substantially all the wear surface 120 that engages the working surface 110 of the vehicle, as illustrated in FIGS. 4A-5B. Said another way, the wear liner 140 may cover the frame 130. The wear liner 140 may have a liner thickness, as measured from the wear surface 120 toward the base of the body 102 of the friction assembly 100, of FIG. 5B. The wear liner 140 may have one or more liner thicknesses. The one or more liner thicknesses may be selected based on a desired friction performance and/or based on the mating working surface 110 of the vehicle engaged by the wear liner 140. For example, the liner thickness may be selected to be thicker at a portion of the wear liner 140 where more engagement with the working surface 110 may be expected.

The frame may have one or more frame thicknesses, as measured from an outer most portion facing the wear surface toward the base of the body of the friction wedge assembly. For example, the portion 129 of the frame spaced apart from the frame attachment surface may have frame thickness that may be less than the frame thickness of an adjacent portion of the frame, as of FIG. 4B. In one example, a portion 190 of the liner thickness may be generally equal to a portion 192 of the frame thickness, as of FIG. 4C. In another example, the liner thickness may be less than one or more of the frame thicknesses, for example between 50% and 99% of the one or more frame thicknesses. In another example, the liner thickness may be greater than one or more of the frame thicknesses, for example between 101% and 200% of the one or more frame thicknesses.

The wear liner 140 may initially engage the working surface 110 exclusive of the frame 130. However, through frictional engagement with the working surface 110, the wear liner 140 may begin to wear, and portions of the wear liner 140 may be removed. Removing portions of the wear liner 140 through frictional engagement may decrease the liner thickness. Specifically, the worn wear liner 140 may expose portions of the frame 130 (e.g., the array 132) that may engage the working surface 110 of the vehicle. While some prior friction assemblies may need to be repaired or replaced when the wear liner is worn, the present friction assembly 100 may be operable when the wear liner is worn, as the exposed frame 130 under the wear liner may serve as a wear surface to frictionally engage the working surface 110 of the vehicle. As the wear liner 140 may be worn, the friction assembly 100 may still be operable in a worn state.

FIG. 6 illustrates the friction wedge assembly of FIG. 1 in another state, according to one example. FIG. 7 illustrates the wear surface removed from the friction wedge assembly in the other state. In one example, the state depicted in FIGS. 6 and 7 may be a worn state. In another example, the state depicted in FIGS. 6 and 7 may be a non-worn state, as further discussed below. When in the worn state, portions of the wear liner 140 may be worn and removed based on the frictional engagement with the working surface 110 of the vehicle. However, the friction assembly 100 may still be operational in the worn state because of the frictional performance characteristics of the frame 130. The worn state may expose portions of the frame 130 under the wear liner 140. Said another way, the wear liner 140 may be worn such that the wear liner 140 may be coplanar with the portions of the frame 130 and may be positioned to engage the working surface 110 together with the frame 130. In the worn state, the friction assembly 100 may be capable of engaging the working surface 110 of the vehicle. Specifically, the exposed portions of the frame 130 may function as a first wear surface and the remaining portions of the wear liner 140 may function as a second wear surface.

In one example, the wear liner 140 may be coupled with the frame 130 such that the wear liner 140 and the frame 130 may be coplanar and may be positioned such that initially, both the wear liner 140 and the frame 130 engage the working surface 110 together. The wear liner 140 may be coupled to the frame 130 such that the wear liner 140 may be positioned in the interstices 134 of the frame 130 without covering the array 132 of the frame 130. As such, the wear liner 140 and the array 132 of the frame 130 may be coplanar and may engage the working surface 110 together. Rather than the wear liner 140 and the array 132 of the frame 130 being coplanar in a worn state, as discussed above, the wear liner 140 and the array 132 of the frame 130 may be coplanar when initially coupled, in a non-worn state.

The combination of the frame 130 and wear liner 140 may allow for customizable frictional performance engaging the working surface 110 of the vehicle. The material of the frame 130 and the material of the wear liner 140 may be selected based on the desired frictional output. The frame 130 may be distributed throughout the liner thickness of the wear liner 140, such that as the whole wear surface 120 (i.e., the frame plus the wear liner) wears, both the frame 130 and the wear liner 140 may contribute to the frictional performance. The frame 130 additionally may provide structural support to the wear liner 140, however, the frame 130 may also contribute to the friction of the overall assembly. The coefficient of friction may be provided by both the frame 130 and the wear liner 140, and each may be customized to provide the friction level and support required for each application. Customization may result from adjusting the material formula of the wear liner 140, the geometry of the frame 130, the ratio of frame 130 to wear liner 140, the type of material/metal used for the frame 130, or the like.

In one example, the frame 130 may be coupled to the friction assembly 100 and then the wear liner 140 may be coupled to the frame 130. When the wear liner 140 is fully worn out, for example, where no portion of the wear liner 140 may engage the working surface 110, the wear liner 140 may be replaced. However, even when the wear liner 140 may be fully worn out, the frame 130 may still provide frictional engagement with the working surface 110 of the vehicle and the friction assembly 100 may still be operable.

In another example, the wear liner 140 may first be coupled with the frame, and then the frame 130 and wear liner 140 may be coupled with the friction assembly 100. The wear liner 140 and frame 130 may be repaired and replaced together when frictional performance may drop below a predetermined threshold. By coupling the wear liner 140 and frame 130 separately from the body 102 of the friction assembly 100, the wear liner 140 and frame 130 may be packaged and shipped separately of the body 102 of the friction assembly 100. As the body 102 of the friction assembly 100 may be larger and heavier than the wear liner 140 and the frame 130, this may improve efficiency of packaging and shipping. This may also reduce damage to the wear liner 140 and the frame 130 during shipping and improve the customization of the friction assemblies based on desired performance and wear constraints.

Additionally, the frame 130 may function as a heat sink for the wear surface 120 and the wear liner 140. The wear liner 140 may be formed from a material that may be deformed, cracked, smeared, or the like, at high temperatures. The frame 130 may transfer heat away from the wear surface 120. In one example, the frame 130 may be fully encapsulated on the wear surface 120 that may be supporting the working surface 110 of the vehicle. The wear surface 120 may be insulative and the frame 130 may not be in frictional engagement with the working surface 110.

In another example, the frame 130 may engage the working surface 110 together with the wear surface 120 of the wear liner 140. The frame 130 may be able to absorb heat from the wear surface 120 and transfer the heat away from the wear surface 120. The frame 130, being formed from metal, may function well as a strong heat sink. In one example, the frame 130 may transfer the received heat to the body of the friction assembly 100 to further dissipate the heat. The transfer of heat away from the wear surface 120 may improve the performance and prolong the life of the wear liner 140.

The frame 130 may be rectangular and may include one or more first cross members 160 and one or more second cross members 162 (FIG. 6). The first cross members 160 may have a first common orientation (e.g., generally vertical) and the second cross members 162 may have a second common orientation (e.g., generally horizontal). As used herein, generally is understood to mean approximately, for example, within 15 degrees. As described above with respect to FIG. 3B and 4C, one or more of the first cross members 160 may have a different thickness extending from the wear surface 120 toward the frame attachment surface 108. One or more of the first cross members 160 may not extend to the frame attachment surface 108. Additionally, one or more of the second cross members 162 may have a different thickness extending from the wear surface 120 toward the frame attachment surface 108. One or more of the second cross members 162 may not extend to the frame attachment surface 108.

The first cross members 160 may be generally parallel to one another, and the second cross members 162 may be generally parallel to one another. In one example, the first common orientation may be generally perpendicular to the second common orientation. The first cross members 160 may interconnect and be integral with the second cross members 162. The first and second cross members 160, 162 may make up and define the array 132 of the frame 130. Each of the interstices 134 may be enclosed by the first cross members 160 and the second cross members 162. While the embodiment of FIG. 6 includes seven first cross members 160, in other embodiments the number of first cross members 160 may be more or less, depending on the desired frictional performance and desired support. The embodiment of FIG. 6 includes four second cross members 162, however, in other embodiments the number of second cross members 162 may be more or less, depending on the desired frictional performance and desired support. Further, the ratio of first cross members 160 to second cross members 162 may vary depending on the desired performance.

The first cross members 160 and the second cross members 162 may each include a facing-side surface. The facing-side surface may be positioned to face and engage the working surface 110. In one example, each of the first cross members 160 and the second cross members 162 may have a respective facing-side surface that may be coplanar with all of the facing-side surfaces of the other first cross members 160 and the second cross members 162. The facing-side surfaces may together define the wear surface 120.

The frame 130 may include a perimeter defined by other cross members. For example, the frame 130 may include one or more lateral first cross members that may extend outwardly beyond the wear liner 140. These one or more lateral first cross members may protect lateral portions of the wear liner from damage, such as premature chipping, shearing, or wear. The frame 130 may include a top and/or bottom second cross members that may extend outwardly beyond the wear liner 140. The top and/or bottom second cross members may protect top/bottom portions of the wear liner from damage, such as premature chipping, shearing, or wear.

The frame 130 may include different shapes and arrangements. The different shapes and arrangements may be based on the desired friction performance of the friction assembly 100, wear rate of the friction assembly 100 and/or the working surface 110 of the vehicle, desired heat distribution from the wear surface 120 to the frame 130, or the like. The first cross members 160 and the second cross members 162 may be arranged to vary the size and number of the interstices 134. The first and second cross members 160, 162 may be arranged to provide for a few relatively large interstices 134, which may provide for more space between the adjacent cross members. In another example, the cross members 160, 162 may be arranged to provide many relatively small interstices, such as a mesh array. This may provide for less space between adjacent cross members. Said another way, the frequency and density of the interstices 134 may be adjusted by adjusting the number and spacing of the first and second cross members 160, 162. Varying the shape and arrangement of the frame 130 may modify the frictional performance, the amount of support provided to the wear liner 140, the wear life of the frame 130, or the like.

Varying the size, number, and arrangement of the cross members 160, 162 and the interstices 134 may vary a ratio of surface area of the array 132 of the frame 130 to the surface area of the interstices 134. In the examples where the wear liner 140 may be positioned in the interstices 134, the surface area of the first wear surface of the frame 130 to the surface area of the second wear surface of the wear liner 140 may be adjusted by adjusting the arrangement and number of the first and second cross members 160, 162. In one example, the surface area of the first wear surface may be less than or equal to the surface area of the second wear surface. Where the surface area of the first wear surface (e.g., the frame 130) may be less than the surface area of the second wear surface (e.g., the wear liner 140), the friction assembly 100 may have a high friction performance range but may have a reduced wear life compared to the surface area of the first wear surface being greater than the second wear surface. This may be because the frame 130 may provide less support and friction, such that the wear liner 140 may be able to provide high friction performance but may wear more quickly with less support and friction provided by the frame 130.

In another example, the surface area of the first wear surface may be greater than or equal to the surface area of the second wear surface. Where the surface area of the first wear surface (e.g., the frame 130) may be greater than the surface area of the second wear surface (e.g., the wear liner 140), the friction assembly 100 may have a low to medium friction performance range but may have an increased wear life compared to the surface area of the first wear surface being less than the second wear surface. The added surface area of the frame 130 may provide additional support and frictional engagement that may reduce the wear level of the wear liner 140.

The frame 130 may include a variety of arrangements or patterns of the array 132 and interstices 134. The arrangements may be selected based on desired friction performance and/or wear rate of the frame 130, the wear liner 140, and/or the working surface 110 of the vehicle. The array 132 and interstices 134 may be arranged in the shape of a diamond, rectangle, triangle, circle, oval, another polygon, irregular shapes, and various combinations thereof.

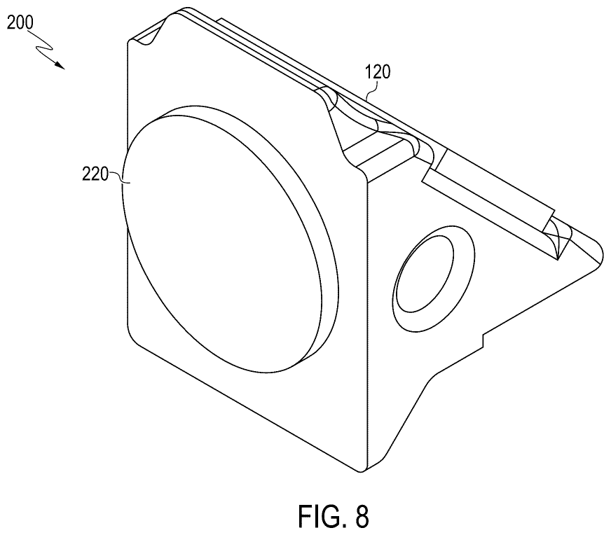

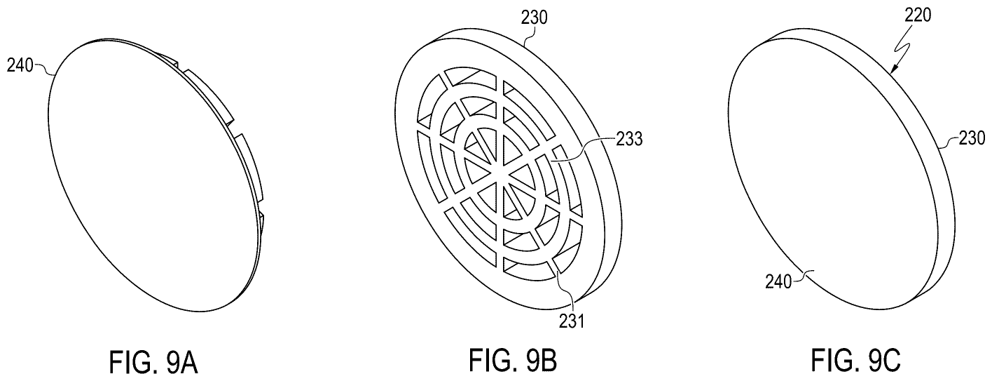

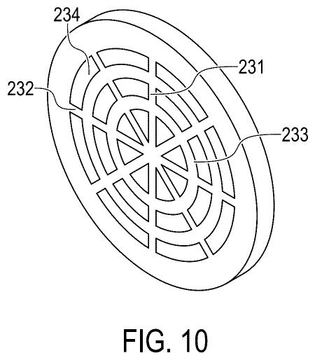

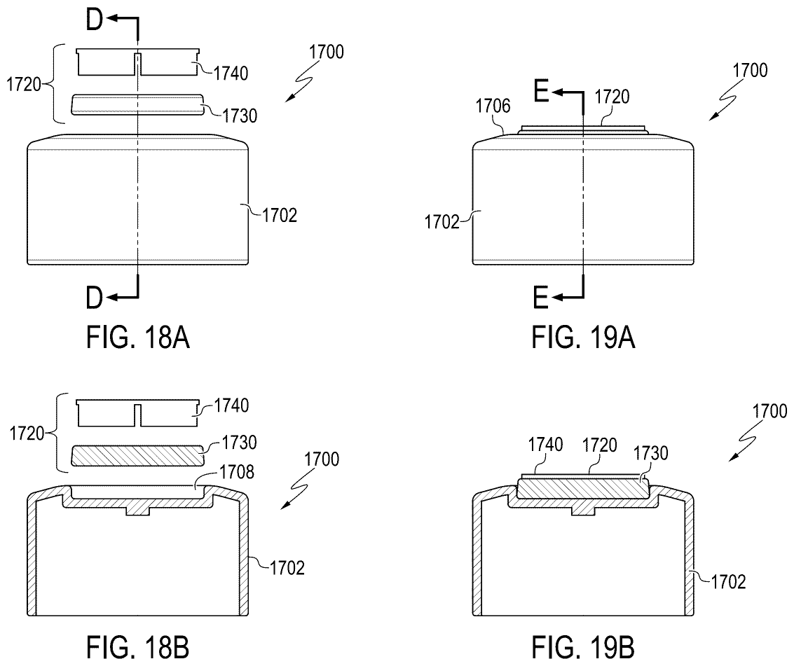

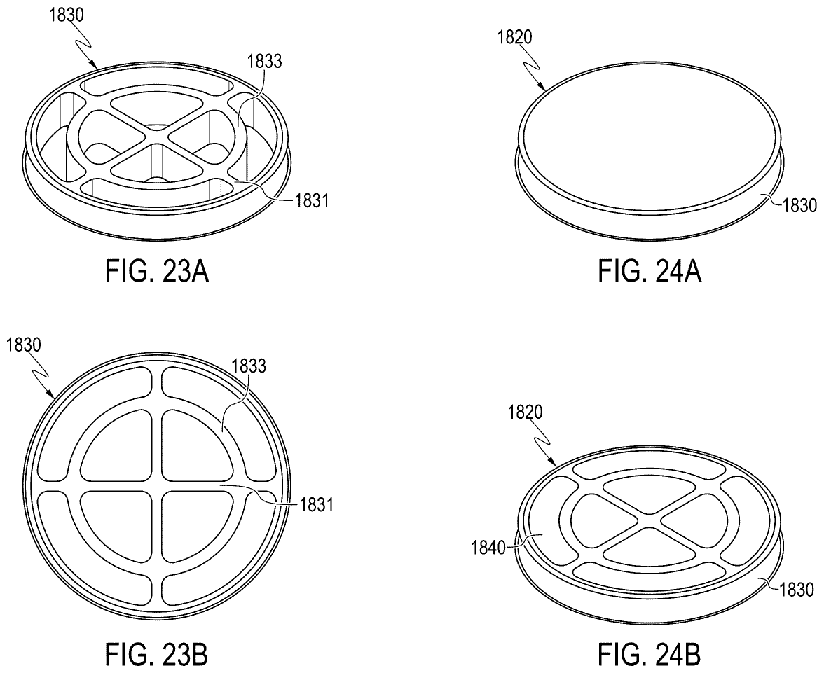

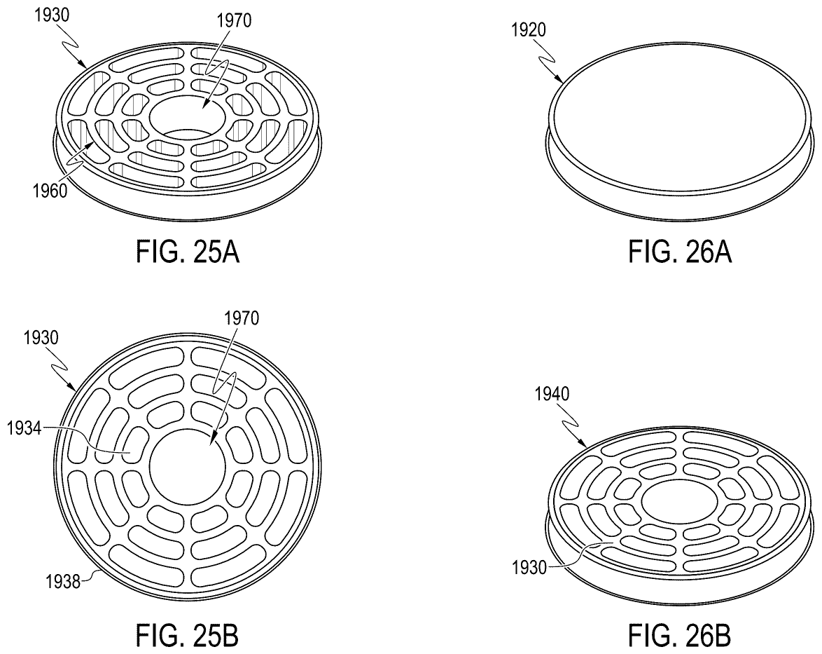

A friction assembly may include a frame, wear liner, and/or wear surface that may be circular (e.g. FIGS. 8-11, 15, and 17-24). For example, referring primarily to FIGS. 8-10, a friction assembly 200 is similar in many aspects to the friction assembly 200 and includes a circular wear surface 220 formed from a circular wear liner 240 and a circular frame 230 that may include one or more linear member 231 that may intersect the circular frame 230. The one or more linear members 231 may include one or more of a vertical member, a horizonal member, a diagonal member, or the like. The linear members 231 may be positioned to intersect, for example, at a center portion of the circular frame 230. The frame 230 may also include one or more circular support portions 233 extending around a central portion of the intersection of the linear members 231. The linear members 231 and circular support portions 233 form an array 232 having interstices defined therein, as disclosed herein with respect to frame 130. The number of circular support portions 233 may be modified based on the desired frictional performance. For example, referring to FIGS. 25A-26B, a frame 1930 is similar in many aspects to the circular frame 230, and includes a mesh array 1960 with a central aperture 1970. The frame 1930 together with a circular wear liner 1940 forms a circular wear surface 1920 and may be used where high frictional performance may be desired because the additional circular support portions may provide additional support and frictional capacity. However, referring to FIGS. 23A-24B, a frame 1830 is similar in many aspects to the circular frame 230, and includes a mesh array 1860 with a central aperture 1870. The frame 1830 together with a circular wear liner 1840 forms a circular wear surface 1820 and may be used where low frictional performance may be desired, a single circular support portion may be included in the frame.

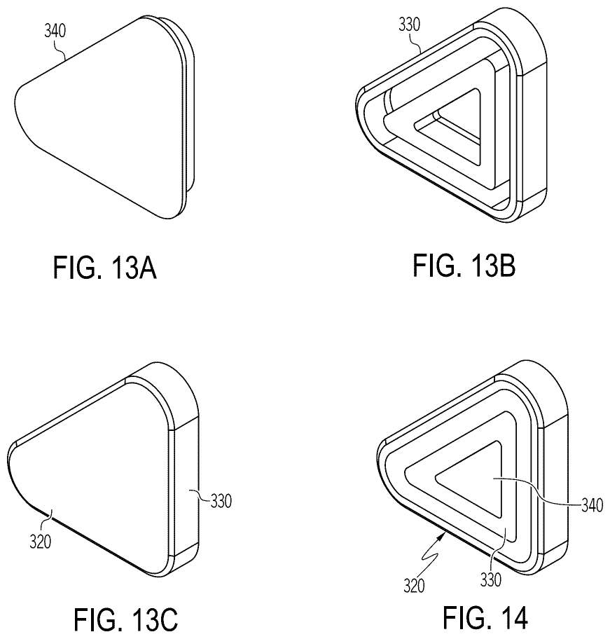

Referring primarily to FIGS. 11-16, a friction assembly 300 is similar in many aspects the friction assembly 200 and may include a triangular side wall 311 supporting a triangular wear surface 320 formed from a triangular frame 330 and triangular wear liner 340. The triangular wear surface 320 may function similarly to the wear surfaces 120, 220 described above, however, the size and shape of the wear surface 320 may be modified to engage a corresponding portion of the working surface 110 of the vehicle. The triangular wear surface 320 may be positioned on the side wall 311 of the body of the friction assembly 300 to engage a corresponding working surface 110 of the vehicle. As discussed above, the frame 330 may be coupled with the wear liner 340, and thus the triangular wear surface 320 may include both the frame 330 and the wear liner 340.

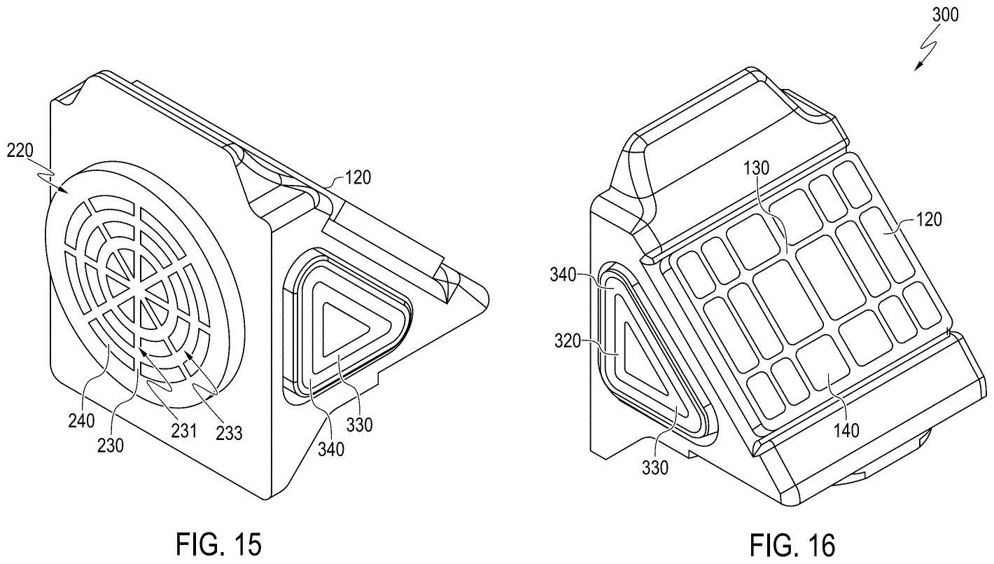

FIGS. 14 and 15 show the triangular wear surface 320 in another state, where the frame 330 and the wear liner 340 may be coplanar and positioned to engage the working surface 110 of the vehicle together. In one example, the state depicted in FIGS. 14 and 15 may be a worn state. In another example, the state depicted in FIGS. 14 and 15 may be a non-worn state. The triangular wear surface 320 may function substantially similarly to the rectangular and circular wear surfaces discussed above.

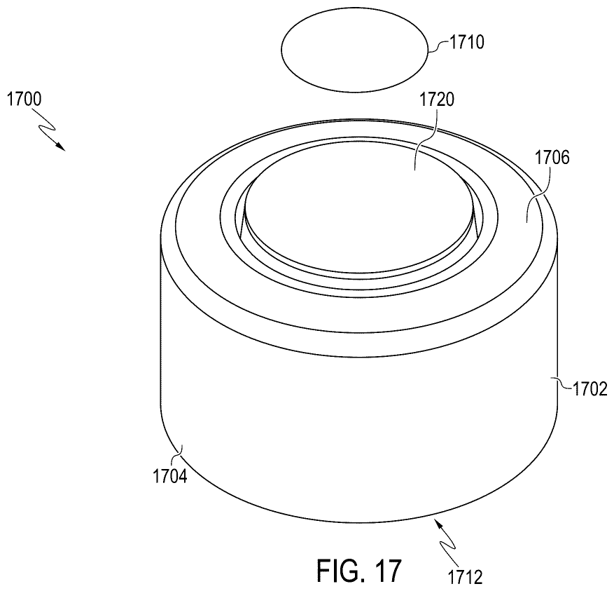

As discussed herein, the friction assemblies 100, 200, and 300 can be friction wedge assemblies; however, the wear surfaces 120, 220, and 320 can be utilized with other friction assemblies, including constant contact side bearings, center bowl liners, coupler carrier wear plates, roller bearing adapters, roller bearing adapter liners, side bearing walls, brake beam extension heads, or the like. FIGS. 17-22 illustrate examples of a constant contact side bearing assembly 1700. The constant contact side bearing assembly may include a body 1702, a side surface 1704, a top surface 1706, a bottom surface 1712, and one or more wear surfaces 1720. The wear surfaces 1720 may be positioned to engage corresponding working surfaces 1710 of a vehicle. As described above, the wear surfaces 1720 may include a frame 1730 and a wear liner 1740. The working surfaces 1710 of the vehicle may be wear plates, side frames, or the like. A frictional force generated by the wear surface's engagement with the working surfaces 110 may dampen movement of the vehicle relative to the constant contact side bearing assembly 1700 and may result in a smoother, less bumpy ride for the vehicle and components thereof. The top surface 1706 may include a frame attachment surface 1708 that may be positioned to receive and/or be coupled with the frame 1730. The frame attachment surface 1708 may be a pocket in the top surface 1706 that may receive the frame 1730. The frame 1730 may frictionally engage a corresponding side wall of the vehicle.

The wear surface 1720, including the wear liner 1740 and the frame 1730, may be positioned to extend above the top surface 1706 of the constant contact side bearing assembly 1700 to engage the working surface 1710 of the vehicle, as shown in FIGS. 19A and 19B. The wear liner 1740 and the frame 1730 may be coupled together and removably coupled with the constant contact side bearing assembly 1700. This may allow for easy replacement of the wear surface 1720 when the frictional performance may be below a desired threshold.

As illustrated in FIGS. 25A, 25B, 26A, and 26B, the frame may be circular and may include a mesh array 1960 with a central aperture 1970. The central aperture 1970, compared to the frames of FIGS. 17-24 may provide a central area for the wear liner to be positioned. The central aperture may correspond to a central portion of the working surface 1710 of the vehicle that may be designed to engage the wear surface 1920. The central aperture 1970 may include the wear liner 1940, which may provide additional friction for the central portion of the working surface. Interstices 1934 of the mesh array, or additional apertures, may extend around the central aperture 1970. As shown in FIG. 25B, the interstices 1934 may increase in size as the interstices get closer to an outer edge 1938 of the frame 1930.

In another example, the interstices may all be a uniform size. In another example, the interstices of the mesh array 1960 may be formed in an irregular pattern and/or irregular shapes, based on desired friction performance and wear characteristics.

Additionally, the mesh array 1960 may provide heat transfer from the wear surface 1920 and the wear liner 1940. The mesh array 1960 may include a greater frame-to-wear-liner ratio, allowing the frame 1930 to absorb and dissipate more heat from the wear surface 1920.

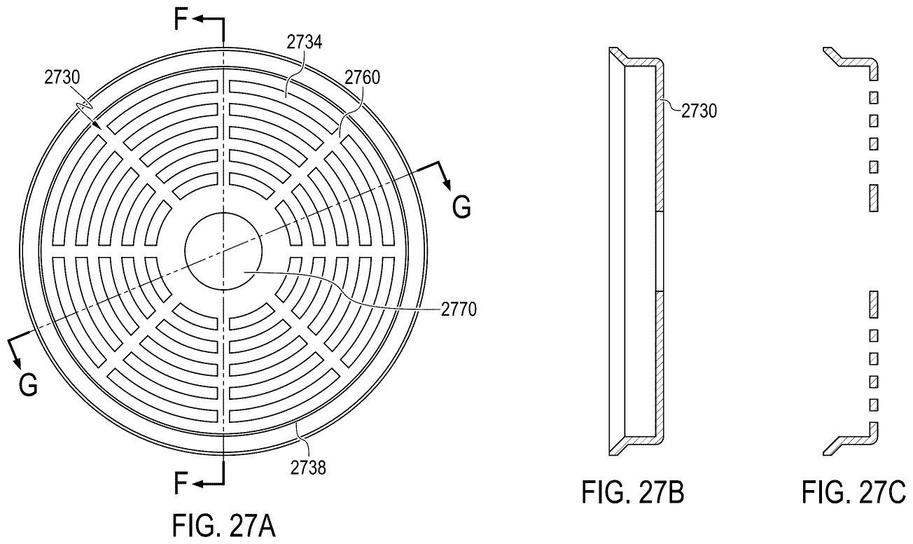

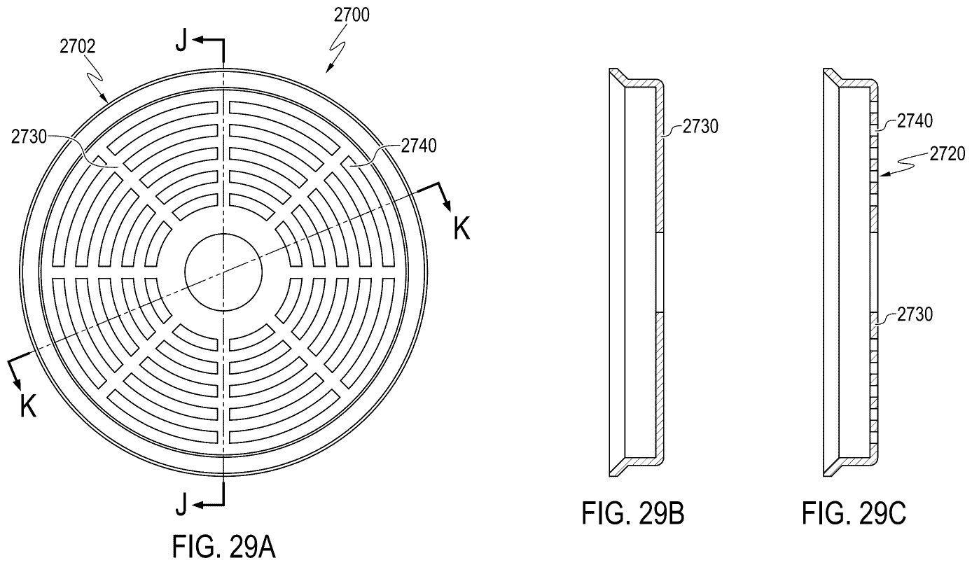

FIGS. 27A-29C illustrate examples of a center bowl liner assembly 2700. The center bowl liner assembly 2700 may include a body 2702 and one or more wear surfaces 2720, which can be similar in many aspects to the wear surfaces (e.g. wear surfaces 120, 220, 320, 1720, 1820, 1920), further disclosed herein. The wear surfaces 2720 may be positioned to engage corresponding working surfaces of a vehicle (e.g. work surfaces 110, 1710). As described above, the wear surfaces 2720 may include a frame 2730 and a wear liner 2740. The working surfaces of the vehicle may be wear plates, side frames, or the like. A frictional force generated by the wear surfaces 2720 engagement with the working surfaces may dampen movement of the vehicle relative to the center bowl liner assembly and may result in a smoother, less bumpy ride for the vehicle and components thereof.

The wear surface 2720, including the wear liner 2740 and the frame 2730, may be positioned to engage the working surface of the vehicle. The wear liner 2740 and the frame 2730 may be coupled together and removably coupled with the center bowl liner assembly 2700. This may allow for easy replacement of the wear surface when the frictional performance may be below a desired threshold.

As illustrated in FIGS. 27A-29C, the frame 2730 may be circular and may include a mesh array 2760 with a central aperture 2770. The central aperture 2770 may provide a central area for the wear liner 2740 to be positioned. The central aperture 2770 may correspond to a central portion of the working surface of the vehicle that may be designed to engage the wear surface 2720. The central aperture 2770 may include the wear liner 2740, which may provide additional friction for the central portion of the working surface. Interstices 2734 of the mesh array, or additional apertures, may extend around the central aperture 2770. Referring primarily to FIG. 27A, the interstices 2734 may increase in size as the interstices 2734 get closer to an outer edge 2738 of the frame 2730. In another example, the interstices 2734 may all be a uniform size. In another example, the interstices 2734 of the mesh array 2760 may be formed in an irregular pattern and/or irregular shapes, based on desired friction performance and wear characteristics.

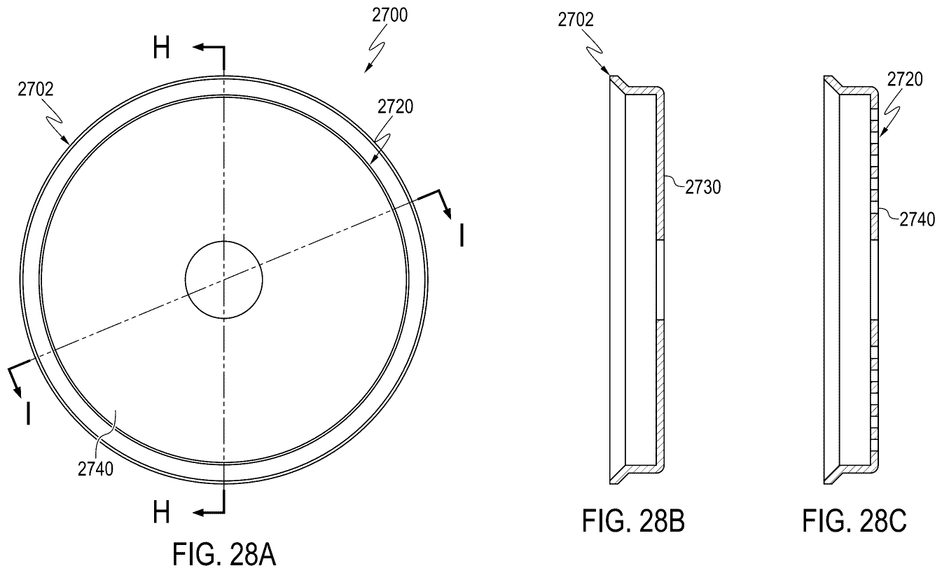

The wear liner 2740 may initially engage the working surface exclusive of the frame 2730, for example in the embodiment illustrated in FIG. 28. However, through frictional engagement with the working surface, the wear liner 2740 may begin to wear, and portions of the wear liner 2740 may be removed. Removing portions of the wear liner 2740 through frictional engagement may decrease the liner thickness. Specifically, the worn wear liner may expose portions of the frame 2730 (e.g., the array) that may engage the working surface of the vehicle. The center bowl liner assembly 2700 may be operable when the wear liner 2740 may be worn, as the exposed frame 2730 under the wear liner 2740 may serve as a wear surface 2720 to frictionally engage the working surface of the vehicle. As the wear liner 2740 may be worn, the center bowl liner assembly 2700 may still be operable in a worn state.

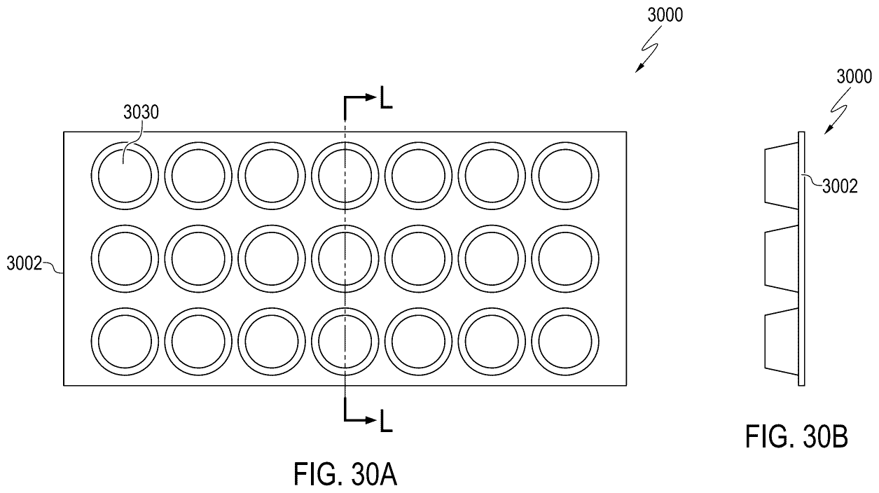

FIGS. 30-34 illustrate examples of a carrier coupler base assembly 3000. The carrier coupler base assembly 3000 may include a body 3002 and one or more wear surfaces 3020, which are similar in many aspects to the to the wear surfaces (e.g. wear surfaces 120, 220, 320, 1720, 1820, 1920, 2720) further disclosed herein. The wear surfaces 3020 may be positioned to engage corresponding working surfaces of a vehicle. As described above, the wear surfaces 3020 may include a frame 3030 and a wear liner 3040. The working surfaces of the vehicle may be wear plates, side frames, or the like. A frictional force generated by the wear surfaces 3020 engagement with the working surfaces may dampen movement of the vehicle relative to the carrier coupler base assembly 3000 and may result in a smoother, less bumpy ride for the vehicle and components thereof.

The wear surface 3020, including the wear liner 3040 and the frame 3030, may be positioned to engage the working surface of the vehicle. The wear liner 3040 and the frame 3030 may be coupled together and removably coupled with the carrier coupler base assembly 3000. This may allow for easy replacement of the wear surface when the frictional performance may be below a desired threshold.

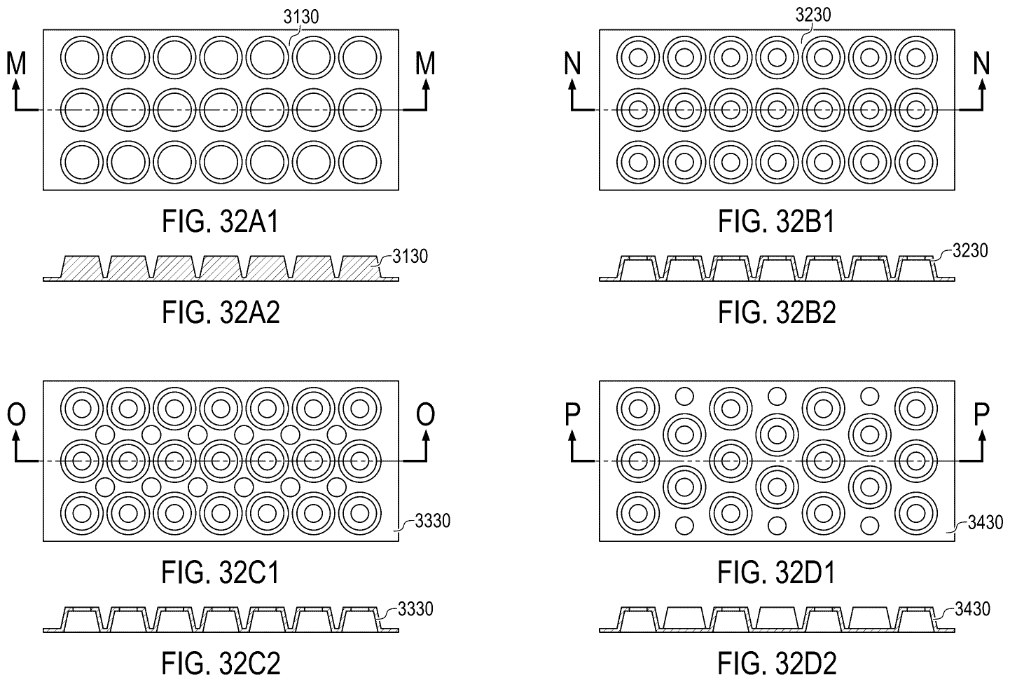

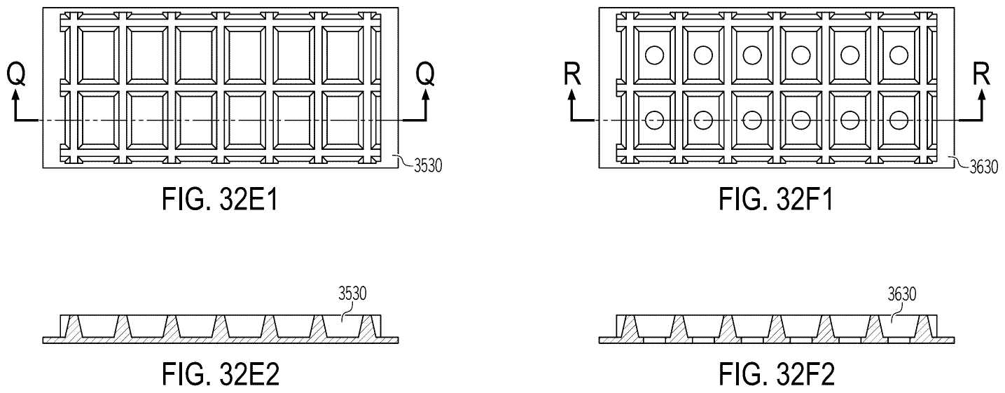

FIGS. 32A1-32F2 illustrates a top view and a cross-sectional view of a frame for a carrier coupler base, such as the carrier coupler base depicted in FIG. 30, according to different examples. The various frames 3130, 3230, 3330, 3430, 3530, 3630 shown in FIGS. 32A1-32F2 depicte alternative shapes, spacing, and arrangements. For example, the frame 3130 may include circular protrusions of uniform size, arranged in a uniform pattern, as shown in FIGS. 32A1 and 32A2. The frame 3230 may include circular protrusions with a circular dimple on a top portion of the protrusion, as shown in FIGS. 32B1 and 32B2. The frame 3330 may include the protrusions and dimples as described in FIGS. 32B1 and 32B2, with additional dimples positioned between the protrusions, as shown in FIGS. 32C1 and 32C2. The frame 3430 may further include protrusions that are arranged in alternating rows of three protrusions and two protrusions, as shown in FIGS. 32D1 and 32D2. The frame 3530 may include rectangular protrusions of uniform size, arranged in a uniform pattern, as shown in FIGS. 32E1 and 32E2. The frame 3630 may include rectangular protrusions with a circular dimple on a top portion of the protrusion, as shown in FIGS. 32F1 and 32F2.

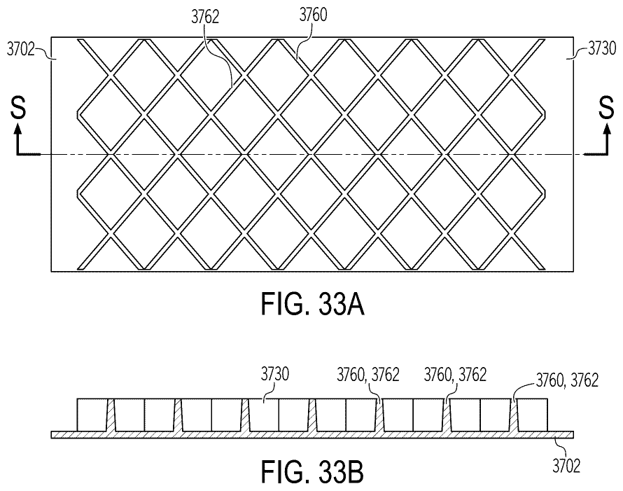

FIGS. 33A and 33B illustrates a frame 3730 of a carrier coupler base, according to one example. The frame 3730 can be similar in many aspects to the various frames further disclosed herein. The frame 3730 may be rectangular and may include one or more first cross members 3760 and one or more second cross members 3762 extending from a base 3702. The first cross members 3760 may have a first common orientation and the second cross members 3762 may have a second common orientation. The first cross members 3760 and the second cross members 3762 may intersect to form a support matrix.

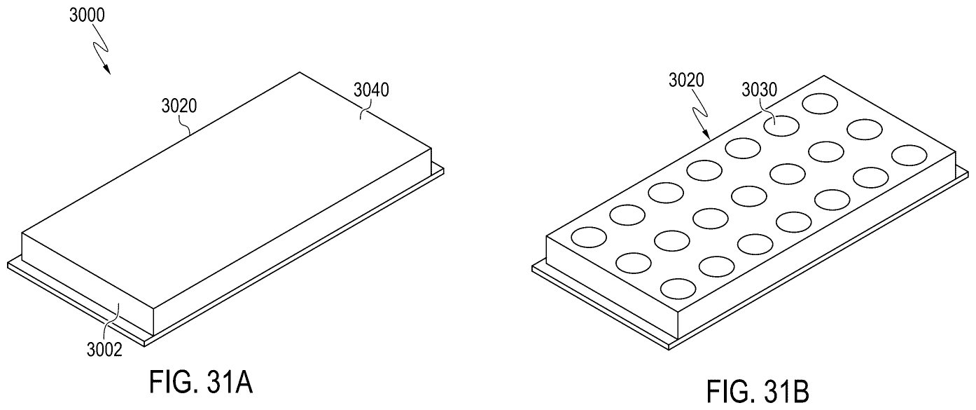

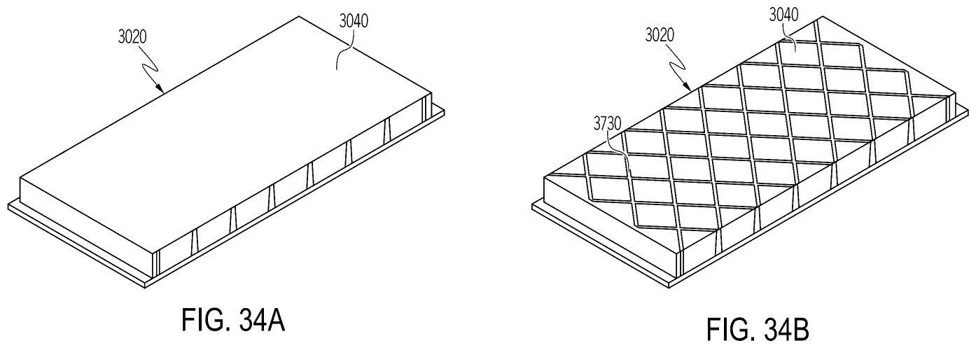

Referring primarily to FIGS. 31A and 34A, the wear liner 3040 may initially engage the working surface exclusive of the frame 3030, 3730 as in the embodiments illustrated in FIGS. 31A and 34A. However, through frictional engagement with the working surface, the wear liner 3040 may begin to wear, and portions of the wear liner 3040 may be removed, as in the embodiments illustrated in FIGS. 31B and 34B. Removing portions of the wear liner 3040 through frictional engagement may decrease the liner thickness. Specifically, the worn wear liner may expose portions of the frame 3030, 3730 (e.g., the array) that may engage the working surface of the vehicle. The carrier coupler base assembly 3000 may be operable when the wear liner 3040 may be worn, as the exposed frame 3030, 3730 under the wear liner 3040 may serve as a wear surface to frictionally engage the working surface of the vehicle. As the wear liner 3040 may be worn, the carrier coupler base assembly 3000 may still be operable in a worn state.

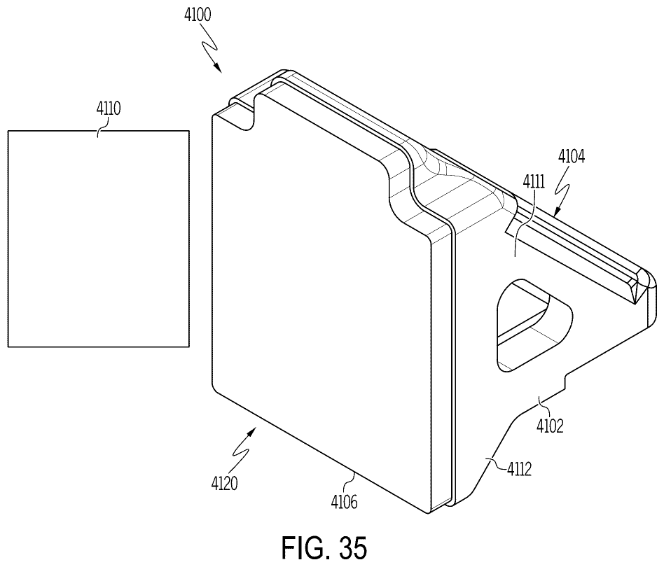

FIG. 35 illustrates an example of a friction assembly 4100, according to at least one example of the present disclosure. The friction assembly 4100 is a friction wedge assembly and is similar in many aspects to the friction assemblies 100, 200, and 300, for example. The friction assembly 4100 in FIG. 35 may be in an initial state, which corresponds to a non-worn state in many aspects of the present disclosure. The friction assembly 4100 is further depicted in another state in FIG. 6, which corresponds to a worn state in many aspects of the present disclosure.

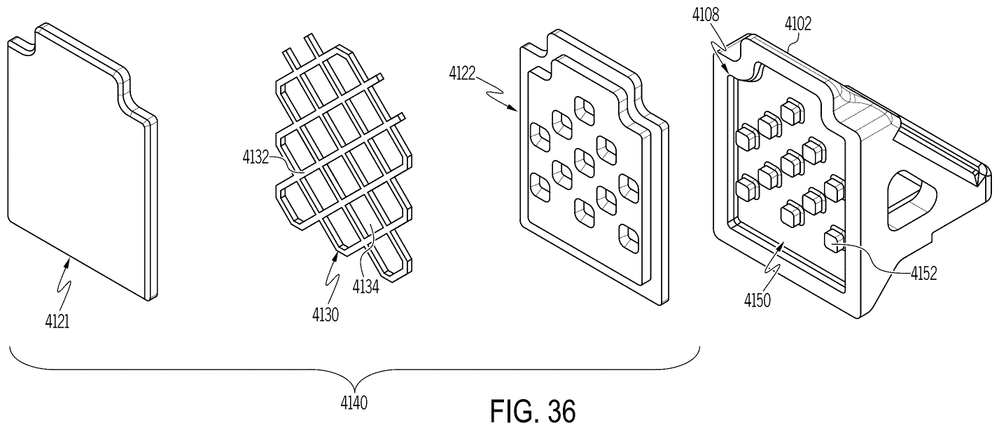

FIG. 36 illustrates an exploded view of the friction assembly 4100. The front surface 4106 may include a first connection side 4108, also referred to herein as an engagement surface, that may be positioned to receive and/or be coupled with a frame 4130. The first connection side 4108, or engagement surface, may include a cavity 4150 having one or more protrusions 4152. In one example, the frame 4130 may be coupled to the protrusions.

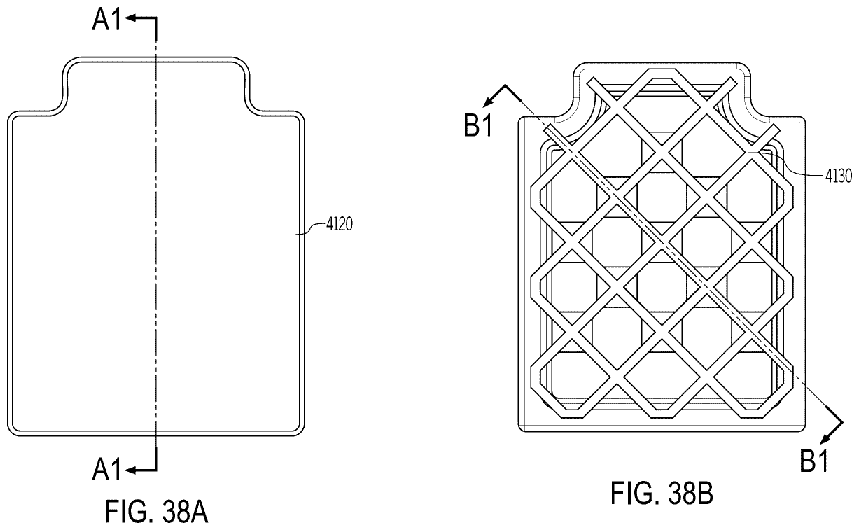

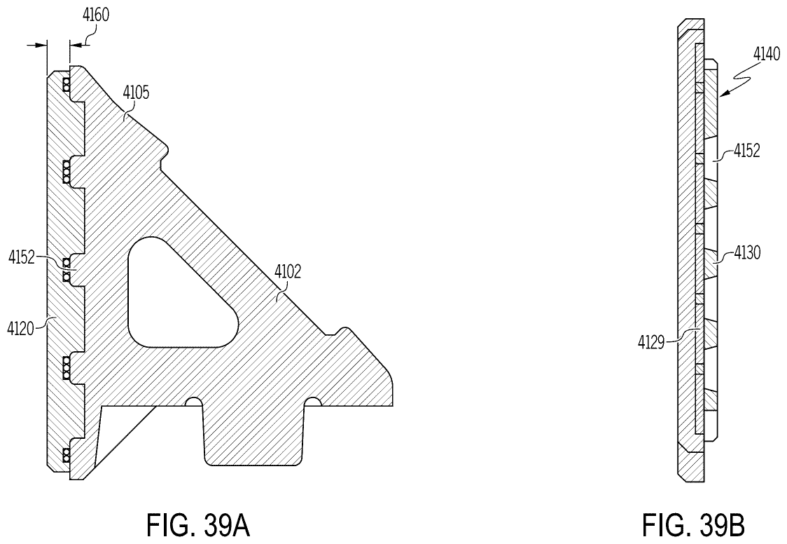

As illustrated in FIG. 36, the wear liner 4140 may have a wear side portion 4121 that may be coupled with the frame 4130 and may engage the working surface of the vehicle. The wear liner 4140 may have a bond side portion 4122 that may be positioned between the frame 4130 and the cavity 4150 and/or protrusions 4152. This arrangement may allow for a greater thickness of the wear liner 4140, as the cavity 4150 provides additional space for the wear liner 4140 and greater bonding strength. The thickness is discussed further below, with reference to FIGS. 39A and 38B. The greater bonding strength may be due in part to the wear liner being positioned fully surrounding and encapsulating the frame, increasing the bonding area. The increased thickness of the wear liner 4140 may increase the durability, effectiveness, and efficiency of the friction assembly.

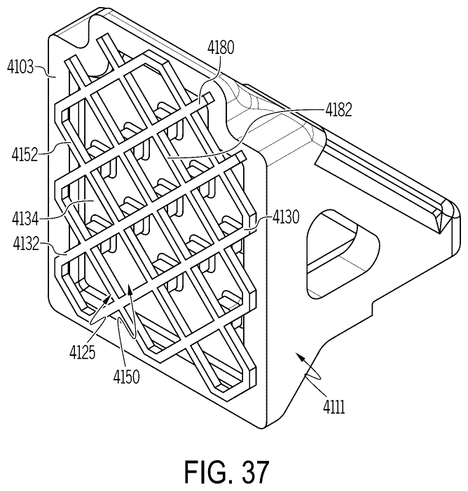

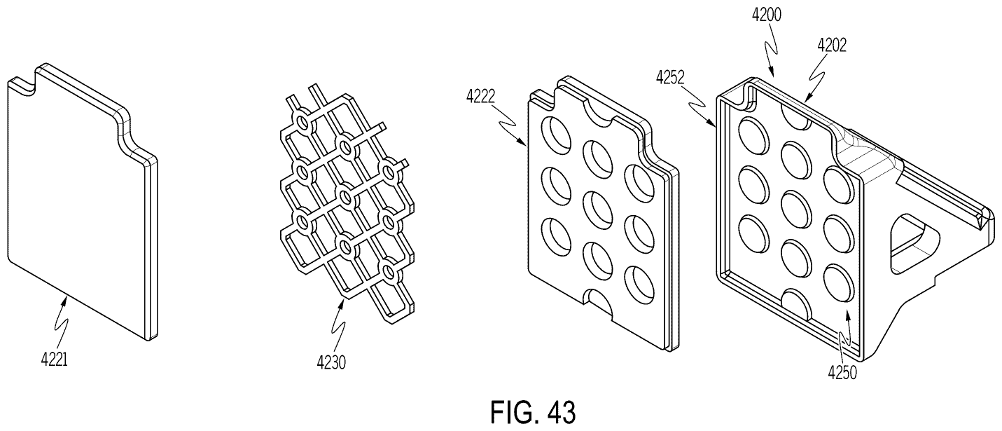

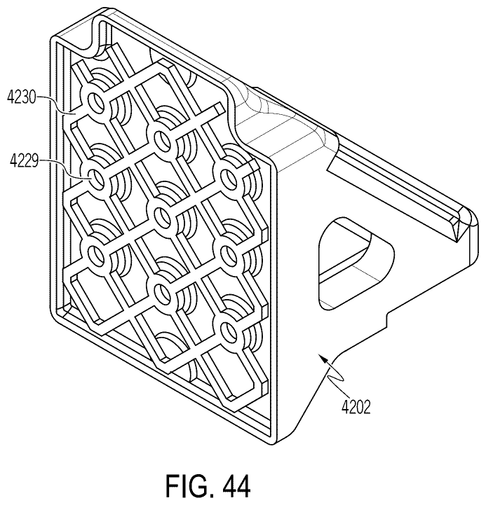

FIG. 37 illustrates a perspective view of the friction assembly 4100 without a wear liner, according to at least one example of the present disclosure. The protrusions 4152 may create a platform that the frame 4130 may be mechanically coupled to. The frame 4130 may be coupled to the protrusions 4152 by welding, mechanical fasteners, press-fit, or the like. The number, shape, and/or pattern of protrusions may be customized based on the desired performance of the friction assembly, as illustrated in the various patterns and geometries disclosed in FIGS. 36, 43, and 50, for example. More protrusions 4152 may be included to provide additional platforms or positions to secure the frame 4130. As illustrated in FIG. 44, a frame 4230 may be similar in many aspects to the frame 4130 and may further include apertures 4229, which may receive mechanical fasteners to couple a frame 4230 to protrusions 4225 (FIG. 43) thereof.

The various protrusions disclosed herein (e.g. protrusions 4152, 4252) may be equally spaced apart or may be randomly aligned on the body. The protrusions may be circular, rectangular, pentagonal, hexagonal, irregularly shaped, or another shape based on desired design and performance. Further, all protrusions for a particular frame may be the same shape and size, or may be varying shapes and/or sizes.

In one example, the frame may be coupled to the body at a perimeter surrounding the cavity 4150. Referring primarily to FIG. 37, the frame 4130 may be coupled to the body 4102 at a perimeter portion 4103. The frame 4130 may be coupled to the perimeter portion 4103 by welding, mechanical fasteners, press-fit, or the like. The perimeter portion 4103 may surround the cavity 4150 on one or more sides. The frame 4130 may be coupled only with the perimeter portion 4103 or may be coupled with the perimeter portion 4103 and the protrusions 4152. The perimeter portion 4103 may extend outwardly towards the working surface further than the cavity 4150. In one example, the perimeter portion 4103 may extend outwardly coplanar with outer-most portions of the protrusions 4152. In another example, the protrusions 4152 may extend outwardly further than the perimeter portion 4103.

The frame 4130 may be coupled with the first connection side, or engagement surface 4108. In other examples, the frame 4130 may be attached to one or more different portions of the friction assembly 4100, specifically, at one or more wear surfaces 4120 of the friction assembly 4100. As described herein with respect to the frame 130 (FIG. 3B), for example, the frame 4130 may be formed from cast iron, forged iron, cast steel, forged steel, sintered metal, alloys, aluminum, 3D printed materials or metals, a combination of metals, or the like. The frame 4130 may be welded to the first connection side 4108, or engagement surface, integrally incorporated into the friction assembly 4100, removably coupled to the first connection side 4108, or engagement surface, via mechanical fasteners, or the like. The frame 4130 may define an array 4132 with interstices 4134. The interstices 4134 can be open areas or passages between the array 4132. A first wear surface 4125 may be disposed around the interstices and may engage the working surface of the vehicle. The material of the frame 4130 may be selected based on a desired friction performance with the working surface of the vehicle. The material of the frame 4130 may also be selected to be rigid to provide support and extended wear life.

Further, the arrangement and pattern of the frame 4130 may be selected based on a desired friction performance. For example, the frame 4130 may be a grid with uniform spacing, as shown in FIGS. 36, 37, and 41.

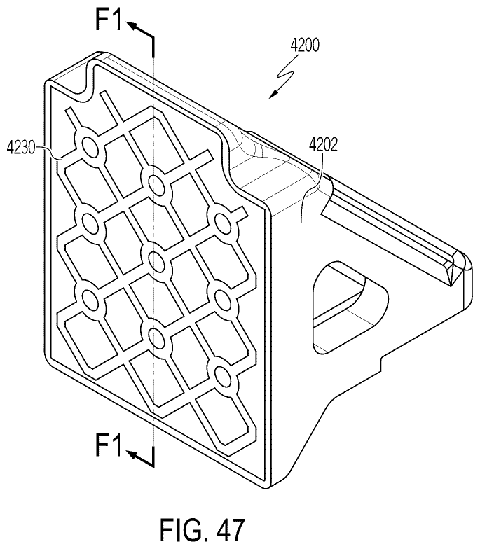

Additionally or alternatively, the frame may include a grid with apertures for receiving mechanical fasteners, as depicted in FIGS. 43, 44, and 47, for example, with respect to the frame 4230. More specifically, a friction assembly 4200 includes a body 4202 and a wear liner 4240 coupled to the body 4202. The friction assembly 4200 and the wear liner 4240 are similar in many aspects to the friction assembly 4100 and the wear liner 4140; however, protrusions 4152 in a cavity 4150 of the body 4202 define a different geometry than those of the friction assembly 4100, and the frame 4130 of the wear liner 4140 includes apertures for receiving mechanical fasteners. Similar to the wear liner 4140, the wear liner 4240 includes a two-part wear liner including a first side 4221 and a second side 4222, and the second side 4222 is positioned between the body 4202 and the frame 4230. Stated differently, the frame 4230 is embedded in the wear liner 4240.

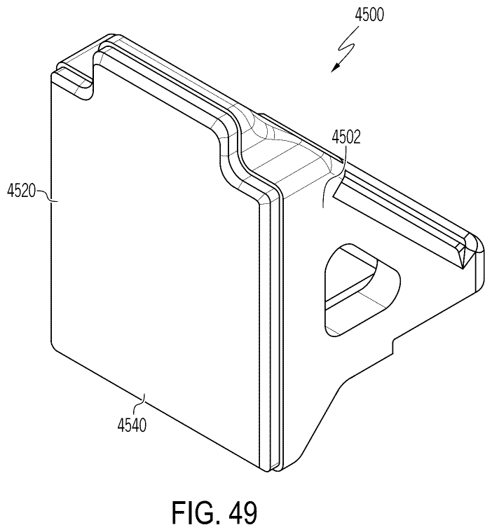

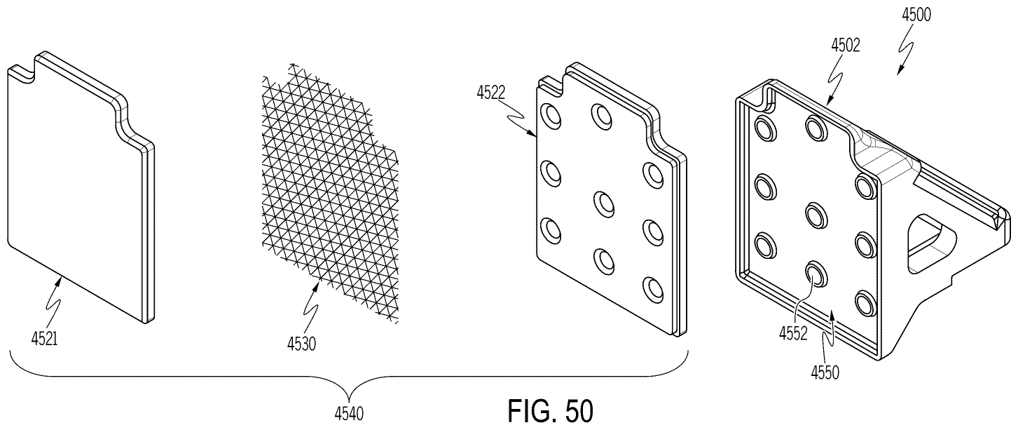

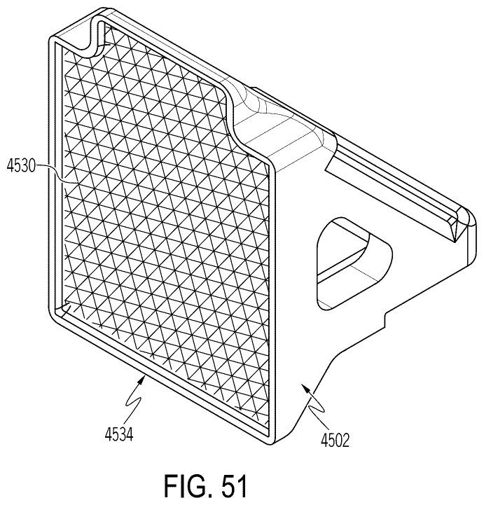

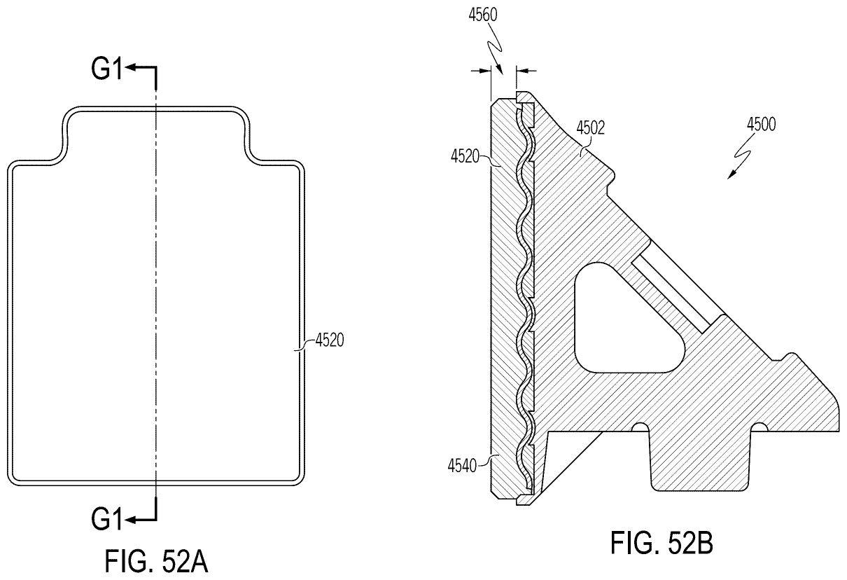

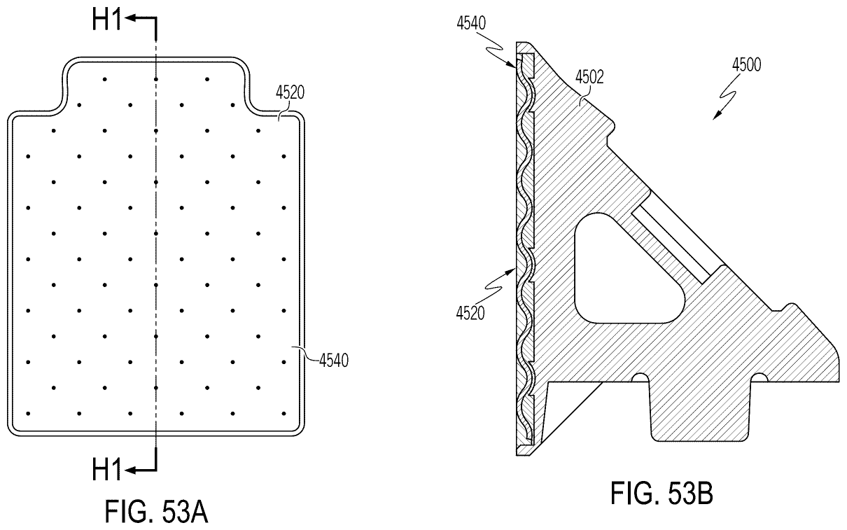

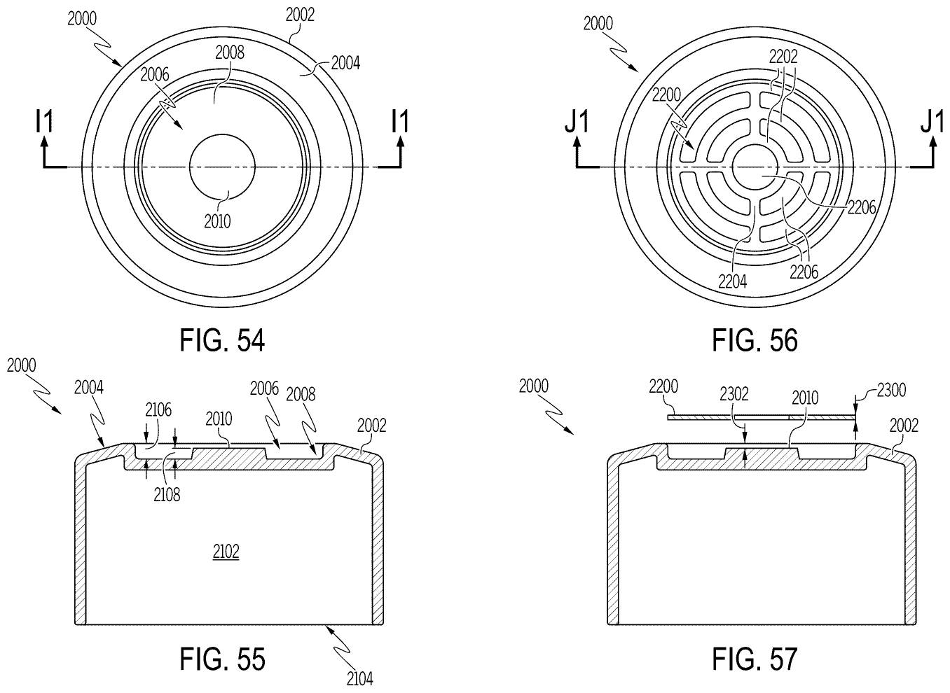

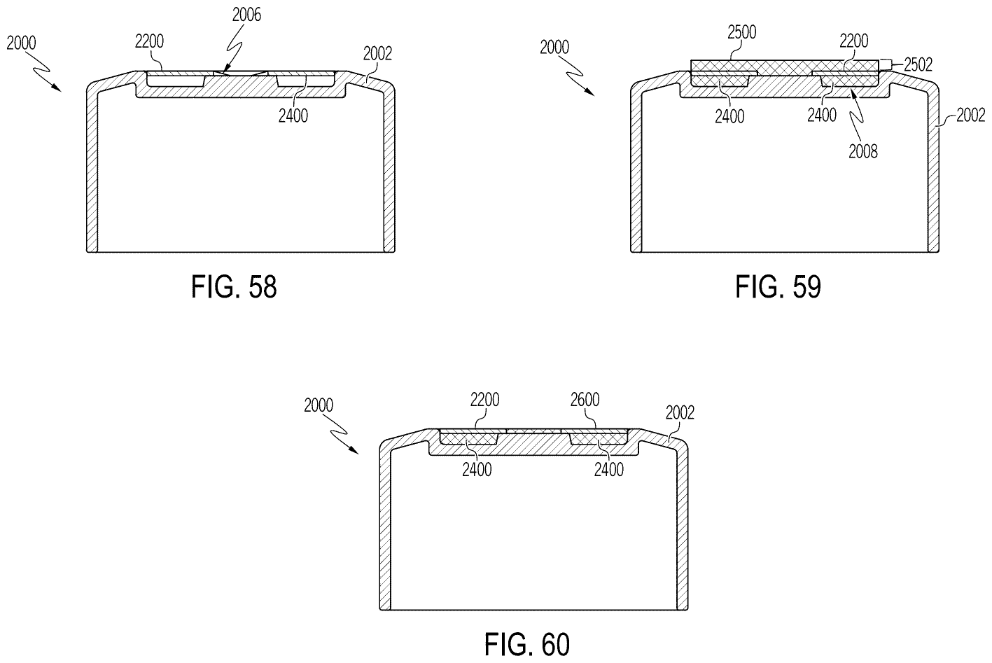

Referring primarily to the friction assembly 4500 and components thereof depicted in FIGS. 49-53B, a frame 4530 thereof may include a denser grid, for example a mesh array, as shown in FIGS. 50 and 51, for example. The arrangement and pattern of the frame 4530 may be selected based on the desired performance or bonding characteristics of the wear liner sides 4521, 4522 and the frame 4530. The selection of the arrangement and pattern of the frame 4530 is discussed further below.

Referring again to the friction assembly 4100 and FIGS. 38A and 38A, the wear liner 4140 is coupled to the frame 4130 to form the wear surface 4120. The frame 4130 may provide a higher degree of structural support compared to the wear liner 4140 coupled to the friction assembly 4100 without the frame 4130. The structural support provided by the frame 4130 may reduce crushing, smearing, deformation, or the like of the wear liner 4140. Additionally, the frame 4130 may provide additional frictional engagement with the wear liner 4140 to the working surfaces of the vehicle. The wear liner 4140 may be coupled to the frame 4130 via chemical bonding (e.g., by adhesive), mechanical fasteners, molding to the frame 4130, or the like.

As illustrated in the cross-section of FIG. 39B, at least the portion 4129 of the frame 4130 may be spaced from the body 4102, such that at least a portion of the wear liner 4140 may be coupled to the frame 4130 between the frame 4130 and the body 4102. The frame 4130 may have multiple portions that may be spaced apart from the body 4102. Additionally, the wear liner 4140 may be coupled to the frame 4130 between the frame 4130 and the wear surface 4120, such that at least a portion of the frame 4130 is surrounded by the wear liner 4140. In other words, the wear liner 4140 may be attached to all sides of the portion 4129 of the frame 4130 to increase the bond strength. The arrangement of the frame 4130 may increase the strength of the bond, as there may be both a mechanical bond and a chemical bond. The array 4132 with interstices 4134 may provide a means of mechanical interlock between the molded wear liner 4140 and the frame 4130. Additionally, the arrangement may reduce the detachment of the wear liner 4140 from the frame 4130 and reduce the chipping, shearing, and/or removal of the wear liner 4140, which may increase the wear life of the wear liner 4140.

In the example illustrated in FIGS. 35-40, the wear liner 4140 may initially be coupled with the frame 4130 such that the wear liner 4140 makes up all or substantially all the wear surface 4120 that engages the working surface of the vehicle. In other words, the wear liner 4140 may cover the frame 4130. The wear liner 4140 may have a wear liner thickness 4160 (FIG. 39A), as measured from the wear surface 4120 toward the base of the body 102 of the friction assembly 4100. The wear liner thickness may be between 2 millimeters and 30 millimeters, preferably between 5-10 millimeters. The cavity 4150 of the body 4102 may allow more space for the wear liner 4140, allowing for a greater wear liner thickness. The greater wear liner thickness may result in increased longevity, performance, and durability. The wear liner 4140 may have one or more liner thicknesses. The one or more wear liner thicknesses may be selected based on a desired friction performance and/or based on the mating working surface of the vehicle engaged by the wear liner. For example, the wear liner thickness may be selected to be thicker at a portion of the wear liner 4140 where more engagement with the working surface may be expected.

The frame 4130 may have one or more frame thicknesses, as measured from an outer most portion facing the wear surface toward the base of the body of the friction wedge assembly. For example, the portion 4129 of the frame 4130 spaced apart from the first connection side 4108, or the engagement surface, may have frame thickness that may be less than the frame thickness of an adjacent portion of the frame 4130. In one example, a portion of the wear liner thickness may be generally equal to a portion of the frame thickness. In another example, the wear liner thickness may be less than one or more of the frame thicknesses, for example between 50% and 99% of the one or more frame thicknesses. In another example, the liner thickness may be greater than one or more of the frame thicknesses, for example between 101% and 200% of the one or more frame thicknesses.

The wear liner 4140 may initially engage the working surface exclusive of the frame 4130. However, through frictional engagement with the working surface, the wear liner 4140 may begin to wear, and portions of the wear liner 4140 may be removed. Removing portions of the wear liner 4140 through frictional engagement may decrease the liner thickness. Specifically, the worn wear liner 4140 may expose portions of the frame 4130 (e.g., the array 4132) that may engage the working surface of the vehicle. While some prior friction assemblies may need to be repaired or replaced when the wear liner is worn, the present friction assembly 4100 may be operable when the wear liner 4140 may be worn, as the exposed frame 4130 under the wear liner 4140 may serve as a wear surface 4120 to frictionally engage the working surface of the vehicle. As the wear liner 4140 may be worn, the friction assembly 4100 may still be operable in a worn state.

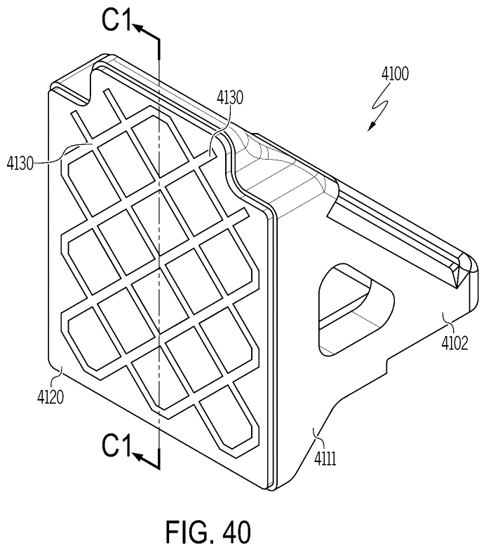

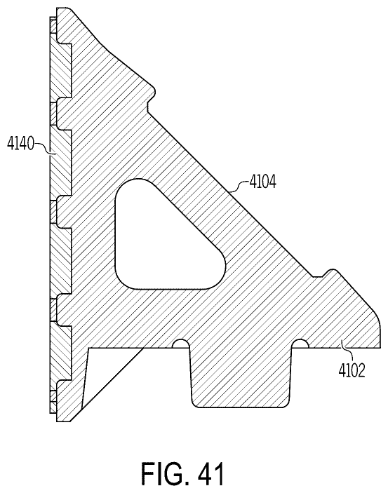

FIG. 40 is a perspective view of the friction assembly of FIG. 35 in another state, according to at least one example of the present disclosure. FIG. 41 is a cross-sectional view along C1-C1 of the friction assembly of FIG. 40, according to at least one example of the present disclosure. In one example, the state of the friction assembly 4100 in FIG. 40 may be a worn state. In another example, the state of the friction assembly 4100 in FIG. 40 may be a non-worn state, as discussed below. When in the worn state, portions of the wear liner 4140 may be worn and removed based on the frictional engagement with the working surface of the vehicle. However, the friction assembly 4100 may still be operational in the worn state because of the frictional performance characteristics of the frame 4130. The worn state may expose portions of the frame 4130 under the wear liner 4140. In other words, the wear liner 4140 may be worn such that the wear liner 4140 may be coplanar with the portions of the frame 4130 and may be positioned engage the working surface together with the frame 4130. In the worn state, the friction assembly 4100 may be capable of engaging the working surface of the vehicle. Specifically, the exposed portions of the frame 4130 may function as a first wear surface and the remaining portions of the wear liner may function as a second wear surface.

In one example, the wear liner 4140 may be coupled with the frame 4130 such that the wear liner 4140 and the frame 4130 may be coplanar and may be positioned such that initially, both the wear liner 4140 and the frame 4130 engage the working surface together, and/or simultaneously. The wear liner 4140 may be coupled to the frame 4130 such that the wear liner 4140 may be positioned in the interstices of the frame 4130 without covering the array of the frame 4130. As such, the wear liner 4140 and the array 4132 of the frame 4130 may be coplanar and may engage the working surface together, and/or simultaneously. Rather than the wear liner 4140 and the array 4132 of the frame 4130 being coplanar in a worn state, as discussed above, the wear liner 4140 and the array 4132 of the frame 4130 may be coplanar when initially coupled, in a non-worn state.

The combination of the frame 4130 and wear liner 4140 may allow for customizable frictional performance engaging the working surface of the vehicle. The material of the frame 4130 and the material of the wear liner 4140 may be selected based on the desired frictional output. The frame 4130 may be distributed throughout the liner thickness of the wear liner 4140, such that as the whole wear surface (e.g., the frame plus the wear liner) wears, both the frame 4130 and the wear liner 4140 may contribute to the frictional performance. The frame 4130 additionally may provide structural support to the wear liner 4140, however, the frame 4130 may also contribute to the friction of the overall assembly. The coefficient of friction may be provided by both the frame 4130 and the wear liner 4140, and each may be customized to provide the friction level and support required for each application. Customization may result from adjusting the material formula of the wear liner 4140, the geometry of the frame 4130, the ratio of frame 4130 to the wear liner 4140, the type of material/metal used for the frame 4130, or the like.

In one example, the frame 4130 may be coupled to the friction assembly 411 and then the wear liner 4140 may be coupled to the frame 4130. When the wear liner 4140 is fully worn out, for example, where no portion of the wear liner 4140 may engage the working surface, the wear liner 4140 may be replaced. However, even when the wear liner 4140 may be fully worn out, the frame 4130 may still provide frictional engagement with the working surface of the vehicle and the friction assembly 4100 may still be operable.

In another example, the wear liner 4140 may first be coupled with the frame 4130, and then the frame 4130 and wear liner 4140 may be coupled with the friction assembly 4100. The wear liner 4140 and frame 4130 may be repaired and replaced together when frictional performance may drop below a predetermined threshold. By coupling the wear liner 4140 and frame 4130 separately from the body 4102 of the friction assembly 4100, the wear liner 4140 and frame 4130 may be packaged and shipped separately of the body 4102 of the friction assembly 4100. As the body 4102 of the friction assembly may be larger and heavier than the wear liner 4140 and the frame 4130, this may improve efficiency of packaging and shipping. This may also reduce damage to the wear liner 4140 and the frame 4130 during shipping and improve the customization of the friction assemblies based on desired performance and wear constraints.

Now, with continued reference to FIGS. 35 and 40, the friction assembly 4100 of FIG. 35 may be in an initial state and the friction assembly 4100 of FIG. 40 may be in a worn state. In FIG. 1, an initial state, for example, may include the wear liner 4140 only engaging the working surface of the vehicle. In FIG. 6, a worn state, for example, may include a first wear surface of the frame engaging a first portion of the working surface of the vehicle and a second wear surface of the wear liner simultaneously engaging a second portion of the working surface of the vehicle. That is, when in a worn state, the first and second wear surfaces of the frame 4130 and the wear liner 4140, respectively, simultaneously or concurrently engage the working surface. In such instances, when in the worn state, the first and second wear surfaces may not engage the same portion of the working surface. Rather, the first and second wear surfaces of the frame 4130 and the wear liner 4140, respectively, engage a first and second portion of the working surface of the vehicle, respectively. The first and second portions of the working surface are adjacent surfaces in various aspects of the present disclosure.

Additionally, the frame 4130 may function as a heat sink for the wear surface 4120 and the wear liner 4140. The wear liner 4140 may be formed from a material that may be deformed, cracked, smeared, or the like, at high temperatures. The frame 4130 may transfer heat away from the wear surface 4120. In one example, the frame 4130 may be fully encapsulated on the wear surface 4120 that may be supporting the working surface of the vehicle. The wear surface 4120 may be insulative and the frame 4130 may not be in frictional engagement with the working surface. In another example, the frame 4130 may engage the working surface together with the wear surface 4120 of the wear liner 4140. The frame 4130 may be able to absorb heat from the wear surface 4120 and transfer the heat away from the wear surface. The frame 4130, being formed from metal, may function well as a strong heat sink. In one example, the frame 4130 may transfer the received heat to the body 4102 of the friction assembly 410 to further dissipate the heat. The transfer of heat away from the wear surface 4120 may improve the performance and prolong the life of the wear liner 4140.

As illustrated in FIGS. 36, 37, 38B, and 40, the frame 4130 may be rectangular and may include one or more first cross members 4180 and one or more second cross members 4182. The first cross members may have a first common orientation (e.g., a first generally diagonal axis) and the second cross members may have a second common orientation (e.g., a second generally diagonal axis). As used herein, generally is understood to mean approximately, for example, within 15 degrees.

The first cross members 4180 may be generally parallel to one another, and the second cross members 4182 may be generally parallel to one another. In one example, the first common orientation may be generally perpendicular to the second common orientation. The first cross members 4180 may interconnect and be integral with the second cross members 4182. The first and second cross members 4180, 4182 may make up and define the array 4132 of the frame 4130. Each of the interstices 4134 may be enclosed by the first cross members 4180 and the second cross members 4182. While the embodiment of FIG. 37 includes six first cross members 4180, in other embodiments the number of first cross members 4180 may be more or less, depending on the desired frictional performance and desired support. The embodiment of FIG. 37 includes six second cross members 4182, however, in other embodiments the number of second cross members 4182 may be more or less, depending on the desired frictional performance and desired support. Further, the ratio of first cross members 4180 to second cross members 4182 may vary depending on the desired performance.

The first cross members 4180 and the second cross members 4182 may each include a facing-side surface. The facing-side surface may be positioned to face and engage the working surface. In one example, each of the first cross members 4180 and the second cross members 4182 may have a respective facing-side surface that may be coplanar with all of the facing-side surfaces of the other first cross members 4180 and the second cross members 4182. The facing-side surfaces may together define the wear surface 4120.

The frame 4130 may include one or more lateral first cross members that may extend outwardly beyond the wear liner 4140. These one or more lateral first cross members may protect lateral portions of the wear liner 4140 from damage, such as premature chipping, shearing, or wear. The frame 4130 may include a top and/or bottom second cross members 4182 that may extend outwardly beyond the wear liner 4140. The top and/or bottom second cross members 4182 may protect top/bottom portions of the wear liner from damage, such as premature chipping, shearing, or wear.

The frame 4130 may include different shapes and arrangements. The different shapes and arrangements may be based on the desired friction performance of the friction assembly 4100, wear rate of the friction assembly 4100 and/or the working surface of the vehicle, desired heat distribution from the wear surface 4120 to the frame 4130, or the like. The first cross members 4180 and the second cross members 4182 may be arranged to vary the size and number of the interstices 4134. The cross members 4180, 4182 may be arranged to provide for a few relatively large interstices 4134, which may provide for more space between the adjacent cross members. In another example, the cross members 4180, 4182 may be arranged to provide many relatively small interstices, such as a mesh array. This may provide for less space between adjacent cross members 4180, 4182. In other words, the frequency and density of the interstices 4134 may be adjusted by adjusting the number and spacing of the cross members 4180, 4182. Varying the shape and arrangement of the frame 4130 may modify the frictional performance, the amount of support provided to the wear liner 4140, the wear life of the frame 4130, or the like.

Varying the size, number, and arrangement of the cross members 4180, 4182 and the interstices 4134 may vary a ratio of surface area of the array 4132 of the frame 4130 to the surface area of the interstices 4134. In the examples where the wear liner 4140 may be positioned in the interstices 4134, the surface area of the first wear surface of the frame 4130 to the surface area of the second wear surface of the wear liner 4140 may be adjusted by adjusting the arrangement and number of the first and second cross members 4180, 4182. In one example, the surface area of the first wear surface may be less than or equal to the surface area of the second wear surface. Where the surface area of the first wear surface (e.g., the frame 4130) may be less than the surface area of the second wear surface (e.g., the wear liner 4140), the friction assembly 4100 may have a high friction performance range but may have a reduced wear life compared to the surface area of the first wear surface being greater than the second wear surface. This may be because the frame 4130 may provide less support and friction, such that the wear liner 4140 may be able to provide high friction performance but may wear more quickly with less support and friction provided by the frame 4130.

In another example, the surface area of the first wear surface may be greater than or equal to the surface area of the second wear surface. Where the surface area of the first wear surface (e.g., the frame 4130) may be greater than the surface area of the second wear surface (e.g., the wear liner 4140), the friction assembly may have a low to medium friction performance range but may have an increased wear life compared to the surface area of the first wear surface being less than the second wear surface. The added surface area of the frame 4130 may provide additional support and frictional engagement that may reduce the wear level of the wear liner 4140.

The frame 4130 may include a variety of arrangements or patterns of the array 4132 and interstices 4134. The arrangements may be selected based on desired friction performance and/or wear rate of the frame 4130, the wear liner 4140, and/or the working surface of the vehicle. The array 132 and interstices 134 may be arranged in the shape of a diamond, rectangle, triangle, circle, oval, another polygon, irregular shapes, and various combinations thereof.

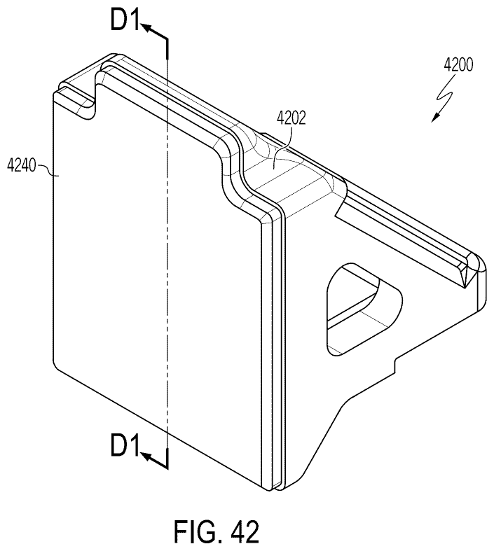

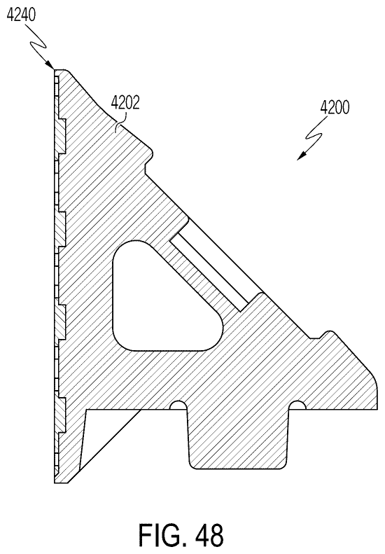

As illustrated in FIGS. 40-53, the frame 4530 may include a mesh array 4530. The mesh array 4530 may include interstices 4534. In one example, the interstices 4534 may all be a uniform size. In another example, the interstices 4534 of the mesh array 4530 may be formed in an irregular pattern and/or irregular shapes, based on desired friction performance and wear characteristics. The mesh array 4530 may provide more surface area for the wear liner 4540 to bond to, which may increase the overall bond strength between the frame 4530 and the wear liner 4540. Similar to the wear liners 4140, 4240, the wear liner 4540 may include a first side and a second side and at least a portion of the wear liner 4540 can be positioned between a body 4502 of the friction assembly 4500 and the mesh array 4530.

Additionally, the mesh array 4530 may provide heat transfer from the wear surface 4520 and the wear liner 4540. The mesh array 4530 may include a greater frame-to-wear-liner ratio, allowing the frame 4530 to absorb and dissipate more heat from the wear surface 4520.

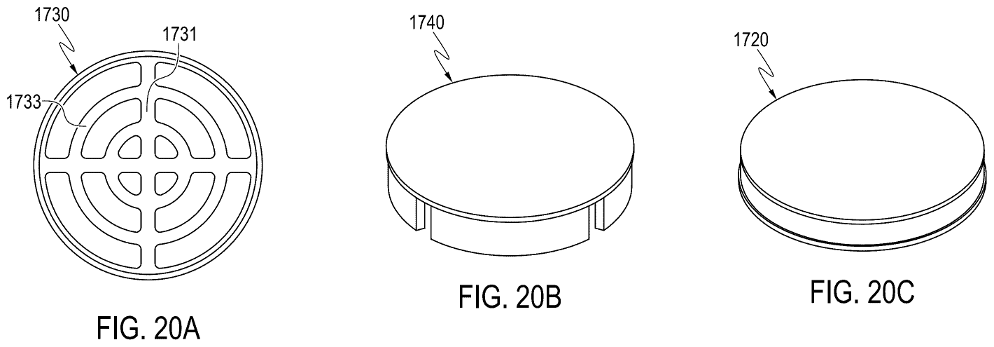

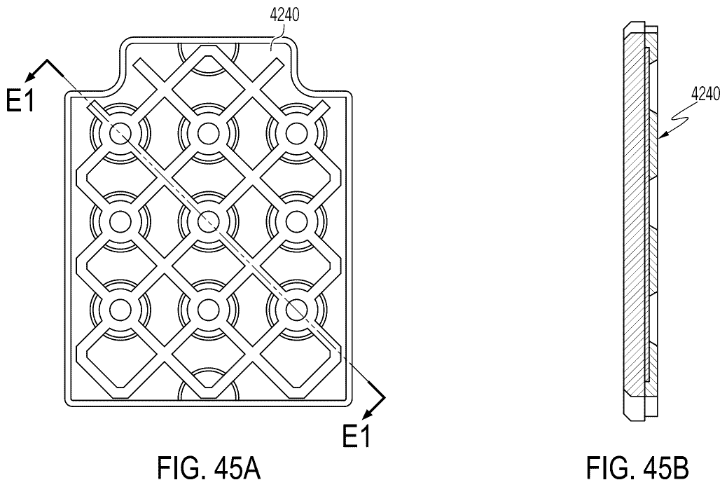

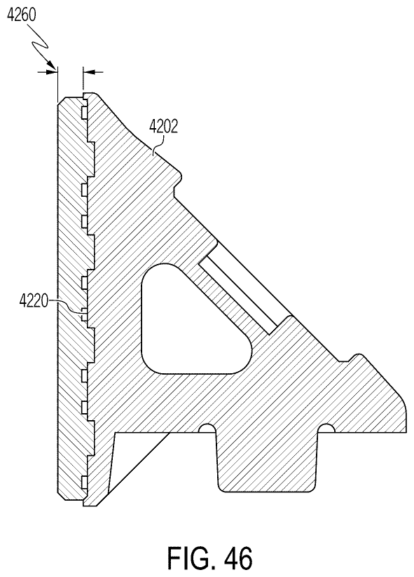

FIG. 45 is a friction assembly 2000, according to at least one example of the present disclosure. FIG. 46 is a cross-sectional view along 11-11 of the friction assembly 2000 of FIG. 20. The friction assembly 2000 can represent a bearing cap. The friction assembly 2000 can include a body 2002 having an internal recess 2102 extending into the body 2002 from a bottom side 2104 of the body 2002. The body 2002 can have a shape of an inverted cup in that the body 2002 extends around a perimeter of the internal recess 2102 and covers a top side of the internal recess 2102 while being open at or along a bottom side of the internal recess 2102.

A wear surface 2004 of the body 2002 extends over the top of the internal recess 2102. A cavity 2006 extends down into the wear surface 2004 toward the bottom side of the body 2002 to a connection surface 2008. This cavity 2006 optionally can be referred to as a pocket or a void. An internal supporting protrusion 2010 may extend upward and away from the connection surface 2008 of the body 2002 within the cavity 2006. This internal supporting protrusion 2010 optionally can be referred to as a weldment perch or a coupling perch. As shown, the internal supporting protrusion 2010 can have a symmetrical shape and is located in a center of the cavity 2006. Optionally, the internal supporting protrusion 2010 may have an asymmetrical shape and/or be offset from the center of the cavity 2006.

The deepest part of the cavity 2006 may extend to a depth distance 2106 into the body 2002 from the wear surface 2004. This depth distance can represent the farthest that the cavity 2006 extends into the body 2002 from the wear surface 2004 to the connection surface 2008 along a direction that is perpendicular to both the wear surface 2004 and the connection surface 2008. The internal supporting protrusion 2010 may extend upward from the connection surface 2008 by a height distance 2108. As of FIG. 55, this height distance of the internal supporting protrusion 2010 is shorter than the depth distance of the cavity 2006.

FIG. 56 is the friction assembly 2000 of FIG. 20, including a frame 2200, according to at least one example of the present disclosure. FIG. 57 is a cross-sectional view along J1-J1 of the friction assembly 2000 of FIG. 56, including the frame 2200 positioned above the cavity 2006 of the friction assembly 2000, according to at least one example of the present disclosure. The frame 2200 may be a friction frame similar to as described above. The frame 2200 can have several concentric circular portions 2202 joined by linear bridge portions 2204 with interstices 2206 between the circular portions 2202 and bridge portions 2204. Optionally, the frame 2200 may have another shape. The frame 2200 optionally can be referred to as a bond mesh or array. The frame 2200 may have a thickness 2300 that is equivalent to a difference 2302 between (a) the depth distance of the cavity 2006 and (b) the height distance of the internal supporting protrusion 2010. The thickness may be the same as this difference, or substantially the same (e.g., within manufacturing tolerances).

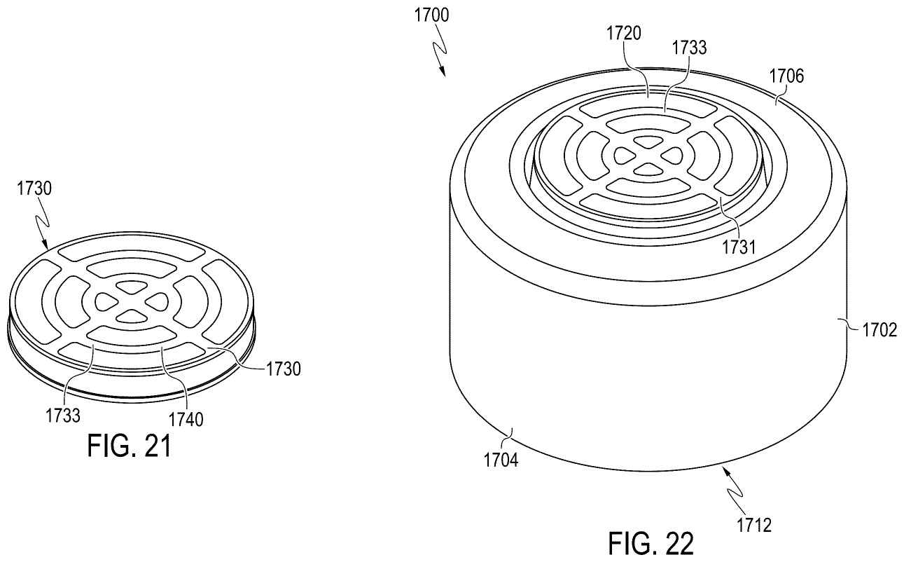

FIG. 57 is a cross-sectional view along J1-J1 of the friction assembly 2000 of FIG. 22, including the frame 2200 positioned inside the cavity 2006 of the friction assembly 2000, according to at least one example of the present disclosure. The frame 2200 may be placed into the cavity 2006 and rest on top of the internal supporting protrusion 2010 or perch. As shown, the frame 2200 may be sized to cover the cavity 2006, thereby leaving circular voids 2400 between the cavity 2006 and the frame 2200. The frame 2200 may be welded or otherwise joined to the body 2002 of the friction assembly 2000. As the thickness of the frame 2200 is equivalent to or substantially equivalent to (e.g., within manufacturing tolerances) the difference between the depth of the cavity 2006 and the height of the internal supporting protrusion 2010, the top surface of the frame 2200 may be coextensive with or coplanar with the top surface of the wear surface 2004.

FIG. 59 is a cross-sectional view along J1-J1 of the friction assembly 2000 of FIG. 56, including a wear liner 2500 in a first state, according to at least one example of the present disclosure. The wear liner 2500 may be formed to extend into and fill the voids in the cavity 2006 between the frame 2200 and the connection surface 2008. The wear liner 2500 may be formed from a flowable composite material that cures or solidifies around the frame 2200. As shown, the wear liner 2500 may fill the voids in the cavity 2006 between the frame 2200 and the connection surface 2008, and may extend through and around the interstices 2206 in the frame 2200. The wear liner 2500 may extend above the frame 2200 as well. The part of the wear liner 2500 extending above the frame 2200 may be a working portion 2502 of the wear liner 2500. This working portion 2502 may contact another component during operation, such as a wheel or other moving part, to slow or stop movement of the other component using friction between the working portion 2502 of the wear liner 2500 and the other component. The wear liner 2500 may completely cover the frame 2200 such that no part of the frame 2200 is visible. Alternatively, one or more parts of the frame 2200 may be visible (e.g., along the outer edges of the frame 2200).

FIG. 60 is a cross-sectional view along J1-J1 of the friction assembly 2000 of FIG. 56, including the wear liner 2500 in a second state, according to at least one example of the present disclosure. Over the useful life of the friction assembly 2000, the working portion 2502 of the wear liner 2500 may wear away and be removed. The working portion 2502 of the wear liner 2500 may eventually be eliminated to an indicator surface, or condemning limit 2600, of the friction assembly 2000. The condemning limit 2600 may be a surface of the friction assembly 2000 that, when visible, indicates that the wear liner 2500 needs to be replaced or the friction assembly 2000 needs to be replaced for continued, safe operation of the vehicle or component using the friction assembly 2000. In the illustrated example, the condemning limit 2600 is the surface of the frame 2200 and the upper parts of the wear surface 2004 that are coextensive or coplanar with each other.

With continued reference to FIGS. 59 and 60, the wear liner 2500 in a first state may include the wear liner 2500 in an initial state, a new state, an unworn state, an unused state, or the like, and the wear liner 2500 in the second state may include the wear liner 2500 in a subsequent state, an old state, a worn state, a used state, or the like.

Frames for friction assemblies are further described herein. The frames can help support the wear liner(s) to prevent or reduce the likelihood of portions of the wear liner(s) breaking off, and the internal supporting protrusion can help support the frame. Without the internal supporting protrusion, pressure imparted on the wear liner may bend or otherwise alter shape of the frame. This, in turn, can cause cracking or other damage to the wear liner, leading to premature failure of the friction assembly.

As described above, the frames and/or the friction assemblies disclosed herein may be made of various materials, included 3D printed metals or materials. Suitable processes for 3D printing may include, for example, laser powder bed fusion, electron beam powder bed fusion, directed energy deposition (DED), and binder jetting. Laser powder bed fusion involves depositing a layer of powder on a build plate and fusing selective portions of the power using an ytterbium fiber laser that scans a CAD pattern. Laser powder bed fusion may include selective laser melting or sintering. At least portions of the frame may be printed using DED, which prints at a very fast rate. For example, DED could be used to print the shell of the frame, which could then be fused directly with the friction assembly. Binder jetting may create a part by intercalating metal powder and polymer binding agent that bind the particles and layers together without the use of laser heating. The material of the frame may be selected based at least in part on the proposed method of additive manufacturing. For example, the binder jet materials that include the binder and the metal (or ceramic, or cermet) may make the green form (e.g., the shape prior to sintering). The green form might be in the final shape, or may be shaped so that the sintered form is the final shape.

The various frames disclosed herein may be formed of at least one plastic, ceramic, and/or metal material. The plastic material may include or represent an epoxy resin, a vinyl ester, a polyester thermosetting polymer (e.g., polyethylene terephthalate (PET)), polypropylene, or the like. The ceramic material may include or represent silica, alumina, silicon nitride, or the like. The metal material may include or represent aluminum alloys, titanium alloys, cobalt chrome alloys, stainless steel, nickel alloys, or the like. The core body may be a composite including a mixture of multiple materials, such as a plastic with a ceramic, a ceramic with a metal (known as a cermet composite material), and/or a plastic with a metal. Optionally, the frame may represent a reinforced composite, such as a fiber-reinforced plastic. The fiber-reinforced plastic may include embedded fibers within a matrix layer of the plastic. The fibers may be carbon fibers, glass fibers, aramid fibers (e.g., Kevlar®), basalt fibers, naturally-occurring biological fibers such as bamboo, and/or the like. The reinforced composite may be reinforced with other shapes of material other than fibers, such as a powder or strips in other embodiments. The reinforcements may be embedded within any of the plastics listed above. The cermet composite material may be composed of any of the ceramics and the metals listed above. For the additive printing process, the materials may be provided in particle form, such as in a powder, and the printing system selectively fuses the particles together to form each layer of the solid build part.

The additive manufacturing system and/or post-printing instruments may be controlled to provide the frames disclosed herein with a specific surface finish that affects how the frame interacts with the working surface. For example, a rougher surface finish may increase friction, increase thermal transfer, and/or increase material transfer through the sidewalls relative to smoother surface finishes. Optionally, the surface finish may be varied along the frame to selectively control the friction and/or transfer conditions throughout the frame.

In one embodiment, a friction assembly is provided that includes a metal frame and a wear liner. The metal frame may define an array with interstices. The metal frame may have a first wear surface disposed around the interstices and may engage a working surface of a vehicle. The wear liner may be coupled to the metal frame within the interstices of the metal frame and define a second wear surface to engage the working surface of the vehicle. The wear liner may cover the first wear surface of the metal frame such that the second wear surface of the wear liner may initially engage the working surface of the vehicle exclusive of the first wear surface. The wear liner may wear down over time through frictional engagement with the working surface until the second wear surface is coplanar with the first wear surface to engage the working surface of the vehicle together. The first wear surface and the second wear surface are coplanar and positioned to engage the working surface of the vehicle together.

In one example, the metal frame may be coupled with a friction wedge, a constant contact side bearing, a bowl liner, a roller bearing adapter, a coupler carrier wear plate, a roller bearing adapter liner, or a side bearing wall of the vehicle. The wear liner may be formed from a composite material. The metal frame may be formed from cast iron, cast steel, or sintered metal.

A surface area of the first wear surface may be less than or equal to a surface area of the second wear surface. A surface area of the first wear surface may be greater than or equal to a surface area of the second wear surface.

The metal frame may include an attachment side opposite the first wear surface. At least a portion of the wear liner may be coupled with the attachment side. The metal frame may include at least three first cross members having a first common orientation and at least three second cross members having a second common orientation. The at least three second cross members may be interconnecting and integral with the at least three first cross members to define the array and the interstices. Each of the interstices may be enclosed at least by a respective two of the at least three first cross members and two of the at least three second cross members. Each of the first cross members and the second cross members may have a respective facing side surface that may be coplanar with all the facing side surfaces of the other first cross members and second cross members to together define the first wear surface.

In one embodiment, a friction component is provided that includes a metal frame and a wear liner. The metal frame may define a mesh array with interstices. The metal frame may have a first friction surface disposed around the interstices and may engage a working surface of a vehicle. The wear liner may be coupled to the metal frame at the interstices of the metal frame and may define a second friction surface to engage the working surface. The wear liner may extend past and cover the first friction surface of the metal frame for the second friction surface of the wear liner to initially engage the working surface of the vehicle exclusive of the first friction surface. The wear liner may wear down over time through frictional engagement with the working surface of the vehicle until the second friction surface is coplanar with the first friction surface to engage the working surface of the vehicle together. The first friction surface and the second friction surface may be coplanar and positioned to engage the working surface of the vehicle together.

In one example, the metal frame may be coupled with a friction wedge, a constant contact side bearing, a bowl liner, a roller bearing adapter, a coupler carrier wear plate, a roller bearing adapter liner, or a side bearing wall of the vehicle. The metal frame may include an attachment side opposite the first friction side. At least a portion of the wear liner may be coupled with the attachment side. The interstices of the mesh array may provide a mechanical interlock between the wear liner and the metal frame.

A surface area of the first friction surface may be greater than or equal to a surface area of the second friction surface. A surface area of the first friction surface may be less than or equal to a surface area of the second friction surface. The metal frame may be formed from cast iron, cast, steel, or sintered metal. The wear liner may be formed from a composite material.

In one example, the metal frame may include at least three first cross members having a first common orientation and at least three second cross members having a second common orientation. The at least three second cross members may be interconnecting and integral with the at least three first cross members to define the mesh array and the interstices. Each of the interstices may be enclosed at least by a respective two of the at least three first cross members and two of the at least three second cross members.

In one embodiment, a friction assembly is provided that includes a body and a wear liner. The body may include a support frame with interstices. The support frame may have a first friction surface disposed around the interstices and may engage a working surface of a vehicle. The wear liner may be coupled to the support frame within the interstices of the support frame and may define a second friction surface that may engage the working surface the vehicle. The wear liner may be coupled with the support frame such that at least a portion of the wear liner is positioned between the support frame and the body. The wear liner may extend past and cover the first friction surface of the support frame for the second friction surface of the wear liner to initially engage the working surface of the vehicle exclusive of the first friction surface. The wear liner may wear down over time through frictional engagement with the working surface of the vehicle until the second friction surface lies within the interstices and is coplanar with the first friction surface to engage the working surface of the vehicle together. The wear liner may define the second friction surface in the interstices of the support frame, and the first friction surface and the second friction surface may be coplanar and positioned to engage the working surface of the vehicle together.

In one example, the support frame may be formed from cast iron, cast steel, or sintered metal. A surface area of the first friction surface may be less than or equal to a surface area of the second friction surface. A surface area of the first friction surface may be greater than or equal to a surface area of the second friction surface. The interstices of the support frame may provide a mechanical interlock between the wear liner and the support frame.

The support frame may include at least three first cross members having a first common orientation and at least three second cross members having a second common orientation. The at least three second cross members may be interconnecting and integral with the at least three first cross members to define the interstices. Each of the interstices may be enclosed at least by a respective two of the at least three first cross members and two of the at least three second cross members.

In one embodiment, a friction assembly is provided that includes a body, a frame, and a wear liner. The body includes a first connection side that may have a cavity with one or more protrusions. The frame may be coupled with the one or more protrusions. The frame may include a first wear surface to engage a working surface of a vehicle. The wear liner may be coupled to the first connection side of the body and the frame. The wear liner may have a second wear surface to engage the working surface of the vehicle. The wear liner may be coupled with the frame such that at least a portion of the wear liner is positioned between the frame and the body.

In one example, the frame may be coupled with a friction wedge, a constant contact side bearing, a bowl liner, a roller bearing adapter, a coupler carrier wear plate, a roller bearing adapter liner, or a side bearing wall of the vehicle. The wear liner may be formed from a composite material. The metal frame may be formed from cast iron, cast steel, aluminum, a 3D printed metal, or sintered metal.

The wear liner may have a thickness of greater than 5 millimeters. A surface area of the first wear surface may be less than or equal to a surface area of the second wear surface. A surface area of the first wear surface may be greater than or equal to a surface area of the second wear surface. The wear liner may be coupled with at least a portion of the cavity.

In accordance with one example or aspect, a friction assembly is provided that includes a metal frame and a wear liner. The metal frame may define an array with interstices. The metal frame may have a first wear surface disposed around the interstices and may engage a working surface of a vehicle. The wear liner may be coupled to the metal frame within the interstices of the metal frame and define a second wear surface to engage the working surface of the vehicle. The wear liner may cover the first wear surface of the metal frame such that the second wear surface of the wear liner may initially engage the working surface of the vehicle exclusive of the first wear surface. The wear liner may wear down over time through frictional engagement with the working surface until the second wear surface is coplanar with the first wear surface to engage the working surface of the vehicle together. The first wear surface and the second wear surface are coplanar and positioned to engage the working surface of the vehicle together.

In accordance with one example or aspect, a friction component is provided that includes a metal frame and a wear liner. The metal frame may define a mesh array with interstices. The metal frame may have a first friction surface disposed around the interstices and may engage a working surface of a vehicle. The wear liner may be coupled to the metal frame at the interstices of the metal frame and may define a second friction surface to engage the working surface. The wear liner may extend past and cover the first friction surface of the metal frame for the second friction surface of the wear liner to initially engage the working surface of the vehicle exclusive of the first friction surface. The wear liner may wear down over time through frictional engagement with the working surface of the vehicle until the second friction surface is coplanar with the first friction surface to engage the working surface of the vehicle together. The first friction surface and the second friction surface may be coplanar and positioned to engage the working surface of the vehicle together.

In one embodiment, a friction assembly is provided that includes a body and a wear liner. The body may include a cavity having one or more protrusions and a support frame with interstices. The support frame may have a first friction surface disposed around the interstices to engage a working surface of a vehicle. The wear liner may be coupled to the support frame and defining a second friction surface to engage the working surface. The wear liner may be coupled with the support frame such that at least a portion of the wear liner may be positioned between the support frame and the body.

In one example, the frame may be coupled with a friction wedge, a constant contact side bearing, a bowl liner, a roller bearing adapter, a coupler carrier wear plate, a roller bearing adapter liner, or a side bearing wall of the vehicle. The interstices of the mesh array may provide a mechanical interlock between the wear liner and the metal frame.

The wear liner may have a thickness that is greater than 5 millimeters. A surface area of the first friction surface may be greater than or equal to a surface area of the second friction surface. A surface area of the first friction surface may be less than or equal to a surface area of the second friction surface. The metal frame may be formed from cast iron, cast steel, aluminum, a 3D printed material, or sintered metal. The wear liner may be formed from a composite material.

In one embodiment, a friction assembly is provided that includes a body and a wear liner. The body may include a support frame with interstices. The support frame may have a first friction surface disposed around the interstices and may engage a working surface of a vehicle. The wear liner may be coupled to the support frame within the interstices of the support frame and may define a second friction surface that may engage the working surface of the vehicle. The wear liner may be coupled with the support frame such that at least a portion of the wear liner is positioned between the support frame and the body.

In one example, the support frame may be formed from cast iron, cast steel, aluminum, a 3D printed material, or sintered metal. A surface area of the first friction surface may be less than or equal to a surface area of the second friction surface. A surface area of the first friction surface may be greater than or equal to a surface area of the second friction surface. The wear liner may have a thickness that is greater than 5 millimeters. The interstices of the support frame may provide a mechanical interlock between the wear liner and the support frame. The wear liner may be coupled with at least a portion of the cavity.

Embodiments may be described in connection with a vehicle, which may be a rail vehicle system, such as a locomotive or switcher, or other type of vehicle systems, such as automobiles, trucks (with or without trailers), buses, marine vessels, aircraft, unmanned aircraft (e.g., drones), mining vehicles, agricultural vehicles, or other off-highway vehicles. Vehicle systems described herein (rail vehicle systems or other vehicle systems that do not travel on rails or tracks) may be formed from a single vehicle or multiple vehicles. With respect to multi-vehicle systems, the vehicles may be mechanically coupled with each other (e.g., by couplers), or virtually or logically coupled but not mechanically coupled. For example, vehicles may be logically but not mechanically coupled when the separate vehicles communicate with each other to coordinate movements of the vehicles with each other so that the vehicles travel together (e.g., as a convoy, swarm, consist, platoon). Calculations and computations, such as navigation processes, may be performed on-board the vehicle systems or off-board the vehicle systems and then communicated to the vehicle systems. Whether on-board or off-board, a vehicle control system may operate a vehicle system and receive and process sensor inputs, operator inputs, operational parameters, vehicle parameters, and route parameters, etc.

Terms such as “processing,” “computing,” “calculating,” or “determining” refer to operations carried out by the control circuit, which may include computing systems or electronic devices that manipulate data represented as physical (electronic) quantities within memory or registers. One or more components may be described as “configured to,” “configurable to,” “operable/operative to,” “adapted/adaptable to,” or similar terms. Unless explicitly stated, these terms encompass components in both active and inactive states. Unless stated otherwise, terms like “including” or “having” should be interpreted as open-ended (i.e., “including but not limited to”). Numeric claim recitations generally mean “at least” the stated number, and disjunctive terms like “A or B” should be interpreted to include either or both unless explicitly specified. Operations in any claim may generally be performed in any order unless explicitly stated. The recitation “at least one of A, B, and C” should be interpreted as any combination of A, B, and C, such A alone, B alone, C alone, A and B together, A and C together, B and C together, and/or A, B, and C together. The recitation “at least one of A, B, or C” should be interpreted to include A alone, B alone, C alone, A and B together, A and C together, B and C together, and/or A, B, and C together.

This written description may disclose several embodiments of the subject matter, including the best mode, and may enable one of ordinary skill in the relevant art to practice the embodiments of subject matter, including making and using any devices or systems and performing any incorporated methods. The patentable scope of the subject matter is defined by the claims, and may include other embodiments that may occur to one of ordinary skill in the art. Such other embodiments may be intended to be within the scope of the claims if they may have structural elements that may not differ from the literal language of the claims, or if they may include equivalent structural elements with insubstantial differences from the literal languages of the claims.

What is claimed is:

1. A friction assembly, comprising:
a body comprising an engagement surface;
a frame secured to the engagement surface; and
a liner secured to the frame, wherein the liner is comprised of a different material than the frame.

2. The friction assembly of claim 1, wherein at least a portion of the liner is positioned between the body and the frame.

3. The friction assembly of claim 2, wherein the frame is embedded in the liner.

4. The friction assembly of claim 1, wherein the body is selected from a group consisting of a friction wedge, a constant contact side bearing, a bowl liner, a roller bearing adapter, a coupler carrier wear plate, a roller bearing adapter liner, and a side bearing wall of a vehicle.

5. The friction assembly of claim 1, wherein the liner is formed from a composite material.

6. The friction assembly of claim 1, wherein the frame is formed from a metal selected from a group consisting of cast iron, cast steel, aluminum, a 3D printed metal, or sintered metal.

7. The friction assembly of claim 1, wherein the liner has a thickness of greater than 5 millimeters.

8. The friction assembly of claim 1, wherein the frame comprises interstices to provide a mechanical interlock between the frame and the liner.

9. The friction assembly of claim 8, wherein the liner is configured to be coupled to the frame within the interstices thereof.

10. The friction assembly of claim 1, wherein the frame defines a mesh array, the mesh array comprising interstices, the interstices configured to provide a mechanical interlock between the frame and the liner.

11. The friction assembly of claim 1, wherein the frame comprises a first wear surface configured to engage a working surface of a vehicle, and wherein the liner comprises a second wear surface configured to engage the working surface of the vehicle.

12. The friction assembly of claim 11, wherein, when the liner is in an initial state, the first wear surface is spaced apart from the working surface and the second wear surface is positioned to engage the working surface.

13. The friction assembly of claim 11, wherein, when the liner is in a worn state, the first wear surface and the second wear surface are co-planar, wherein the first wear surface is configured to engage a first portion of the working surface and the second wear surface is configured to simultaneously engage a second portion of the working surface.

14. The friction assembly of claim 1, wherein the engagement surface comprises a cavity, wherein the cavity comprises a protrusion, and wherein the frame is coupled to the protrusion.

15. A friction assembly, comprising:
a body comprising a support frame having interstices defined therein, the support frame comprising a first friction surface disposed around the interstices and configured to engage a working surface of a vehicle; and
a wear liner configured to be coupled to the support frame within the interstices of the support frame and comprising a second friction surface configured to engage the working surface the vehicle;
wherein one of:
the wear liner extends past and covers the first friction surface of the support frame for the second friction surface of the wear liner to initially engage the working surface of the vehicle exclusive of the first friction surface, the wear liner configured to wear down over time through frictional engagement with the working surface of the vehicle until the second friction surface lies within the interstices and is coplanar with the first friction surface to engage the working surface of the vehicle together; or
the wear liner defines the second friction surface in the interstices of the support frame, and the first friction surface and the second friction surface are coplanar and positioned to engage the working surface of the vehicle together.
